(19) United States
(12) Patent Application Publication
(10) Pub. No.: US 2021/0352326 A1
(43) Pub. Date: Nov. 11, 2021

(54) METHOD AND DEVICE FOR ENCODING/DECODING IMAGES, AND RECORDING MEDIUM FOR STORING BITSTREAM

(71) Applicants: Electronics and Telecommunications Research Institute, Daejeon (KR); CHIPS&MEDIA, INC, Seoul (KR); INDUSTRY ACADEMY COOPERATION FOUNDATION OF SEJONG UNIVERSITY, Seoul (KR); INDUSTRY-UNIVERSITY COOPERATION FOUNDATION KOREA AEROSPACE UNIVERSITY, Goyang-si Gyeonggi-do (KR)

(72) Inventors: Sung Chang LIM, Daejeon (KR); Jung Won KANG, Daejeon (KR); Ha Hyun LEE, Seoul (KR); Jin Ho LEE, Daejeon (KR); Hui Yong KIM, Daejeon (KR); Dae Yeon KIM, Seoul (KR); Dong Jin PARK, Seoul (KR); Wook Je JEONG, Gwacheon-si Gyeonggi-do (KR); Yung Lyul LEE, Seoul (KR); Jae Gon KIM, Goyang-si Gyeonggi-do (KR)

(73) Assignees: Electronics and Telecommunications Research Institute, Daejeon (KR); CHIPS&MEDIA, INC, Seoul (KR); INDUSTRY ACADEMY COOPERATION FOUNDATION OF SEJONG UNIVERSITY, Seoul (KR); INDUSTRY-UNIVERSITY COOPERATION FOUNDATION KOREA AEROSPACE UNIVERSITY, Goyang-si Gyeonggi-do (KR)

(21) Appl. No.: 17/278,097

(22) PCT Filed: Sep. 19, 2019
(86) PCT No.: PCT/KR2019/012172

§ 371 Date: Mar. 19, 2021

(30) Foreign Application Priority Data
Sep. 19, 2018 (KR) 10-2018-0112484

(51) Int. Cl. H04N 19/61; H04N 19/159; H04N 19/88; H04N 19/18; H04N 19/176

(52) U.S. Cl. CPC H04N 19/619; H04N 19/159; H04N 19/176; H04N 19/18; H04N 19/88

(57) ABSTRACT

The present specification discloses a method of decoding an image. The method includes performing dequantization on a current block to obtain a transform coefficient of the current block; performing at least one inverse transform of primary inverse transform and secondary inverse transform on the transform coefficient of the current block to obtain a residual block of the current block; and adding the residual block of the current block and a prediction block of the current block to obtain a reconstructed block of the current block, wherein the secondary inverse transform is performed only when the current block is in an intra prediction mode.

### TECHNICAL FIELD

The present invention relates to a method and apparatus for encoding/decoding an image, more particularly, the present invention relates to a transformation and quantization methods for residual signals and a transform coefficient entropy encoding/decoding method and apparatus thereof.

### BACKGROUND ART

The image encoder transforms a residual signal, which is a difference between an original signal and a prediction signal, and performs encoding of quantized transform coefficients. The image decoder decodes and inverse transforms the quantized transform coefficients to derive the decoded residual signal and adds the same to the prediction signal to produce a decoded signal.

When transforming the residual signal, the conventional technique has a limitation of energy compression performance during transform because the encoder can use one transform kernel in each of horizontal and vertical directions or only the same transform kernel in both directions among the transform kernels. Accordingly, there is a need for a method capable of improving energy compression performance by using at least one transform kernel in consideration of characteristics of the residual signal, thereby improving encoding compression performance and image quality.

### DISCLOSURE

### Technical Problem

The present invention enables the use of at least one or more transform kernels in each of horizontal and vertical directions when transforming the residual signal.

The present invention provides an efficient entropy encoding and decoding method of transform coefficient when using one or more transform kernels.

### Technical Solution

A method of decoding an image according to an embodiment of the present invention, the method may comprise performing dequantization on a current block to obtain a transform coefficient of the current block; performing at least one inverse transform of primary inverse transform and secondary inverse transform on the transform coefficient of the current block to obtain a residual block of the current block; and adding the residual block of the current block and a prediction block of the current block to obtain a reconstructed block of the current block, wherein the secondary inverse transform is performed only when the current block is in an intra prediction mode.

In the method of decoding an image according to the present invention, wherein the secondary inverse transform is performed between the dequantization and the primary inverse transform.

In the method of decoding an image according to the present invention, wherein the secondary inverse transform is performed using a low frequency inverse transform.

In the method of decoding an image according to the present invention, wherein the secondary inverse transform uses a transform method determined according to the intra prediction mode of the current block.

In the method of decoding an image according to the present invention, wherein the secondary inverse transform uses a transform method determined according to transform method selection information obtained from a bitstream.

In the method of decoding an image according to the present invention, wherein whether to perform the secondary inverse transform is determined on the basis of a size of the current block.

In the method of decoding an image according to the present invention, wherein the secondary inverse transform is performed after rearranging the transform coefficient of the current block from a 2D block format to a 1D list format.

In the method of decoding an image according to the present invention, wherein the secondary inverse transform is performed in an application range determined on the basis of a smaller value of a width or a height of the current block.

A method of encoding an image according to an embodiment of the present invention, the method may comprise using a prediction block of a current block to obtain a residual block of the current block; performing at least one transform of primary transform and secondary transform on the residual block of the current block to obtain a transform coefficient of the current block; and performing quantization on the transform coefficient of the current block, wherein the secondary transform is performed only when the current block is in an intra prediction mode.

In the method of encoding an image according to the present invention, wherein the secondary transform is performed between the quantization and the primary transform.

In the method of encoding an image according to the present invention, wherein the secondary transform, is performed using a low frequency transform.

In the method of encoding an image according to the present invention, wherein the method farther comprises encoding transform method selection information indicating a transform method of the secondary transform on the basis of the intra prediction mode of the current block.

In the method of encoding an image according to the present invention, wherein whether to perform the secondary transform is determined on the basis of a size of the current block.

In the method of encoding an image according to the present invention, wherein the secondary transform, is performed after rearranging the transform coefficients of the current block from, a 2D block format, to a 1D list format.

In the method of encoding an image according to the present invention, wherein the secondary transform is performed in an application range determined on the basis of a smaller value of a width or a height of the current block.

A non-transitory computer readable recording medium including a bitstream decoded by an image decoding device according to an embodiment of the present invention, wherein the bitstream includes transform method selection information; the transform method selection information indicates a transform method of secondary inverse transform in the image decoding device; and the secondary inverse transform is performed only when the current block is in the intra prediction mode.

### Advantageous Effects

According to the present invention, when transforming a residual signal into a frequency domain, compression efficiency can be improved by using at least one transform kernel in each of horizontal and vertical directions and performing efficient entropy encoding and decoding for transform coefficient.

According to the present invention, it is possible to improve encoding and decoding efficiency of an image.

According to the present invention, the computational complexity of the encoder and the decoder of an image can be reduced.

### DESCRIPTION OF DRAWINGS

FIG. 1 is a block diagram illustrating a configuration of an encoding apparatus according to an embodiment of the present invention

FIG. 2 is a block diagram illustrating a configuration of a decoding apparatus according to an embodiment of the present invention.

FIG. 3 is a diagram schematically illustrating a division structure of an image when encoding and decoding the image.

FIG. 4 is a diagram illustrating an embodiment of an intra prediction process.

FIG. 5 is a diagram illustrating an embodiment of an inter prediction process.

FIG. 6 is a diagram illustrating a process of transform and quantization.

FIG. 7 is a diagram illustrating reference samples available for intra prediction.

FIG. 8 is a flowchart illustrating an encoding method of an image encoding apparatus according to the present invention.

FIG. 9 is a flowchart illustrating a decoding method of an image decoding apparatus according to the present invention.

FIG. 10 is a diagram illustrating an embodiment of residual signal encoding according to the present invention,

FIG. 11 is a diagram illustrating an embodiment of residual signal decoding according to the present invention.

FIG. 12 is a diagram illustrating an example of a residual signal block.

FIG. 13 is a diagram illustrating an example of a transform coefficient block and a low frequency position.

FIG. 14 is a diagram illustrating an example of a DC inverse transform.

FIG. 15 is a diagram illustrating an example of a low frequency inverse transform.

FIG. 16 is a diagram illustrating an example of DCT-2 basis vectors used for a primary transform.

FIG. 17 is a diagram illustrating an example of DST-7 basis vectors used for a secondary transform.

FIG. 18 is a diagram illustrating an example of performing entropy encoding in combination of a primary transform coefficient block and a secondary transform coefficient block.

FIG. 19 is a diagram illustrating an example of decomposing a combined transform coefficient block into a primary transform coefficient block and a secondary transform coefficient block.

FIG. 20 is a diagram illustrating an example in which two or more binarization methods are combined to binarize a transform coefficient.

FIG. 21 is a diagram illustrating an example of a DCT-2 basis vector.

FIG. 22 is a diagram illustrating an example of a DCT-8 basis vector.

FIG. 23 is a diagram illustrating an example of a DST-7 basis vector.

FIG. 24 is a flowchart illustrating an image decoding method according to an embodiment of the present invention.

FIG. 25 is a flowchart illustrating an image encoding method according to an embodiment of the present invention,

FIG. 26 is a flowchart illustrating an image decoding method according to an embodiment of the present invention.

FIG. 27 is a flowchart illustrating an image encoding method according to an embodiment of the present invention.

### MODE FOR INVENTION

A variety of modifications may be made to the present invention and there are various embodiments of the present invention, examples of which will now be provided with reference to drawings and described in detail. However, the present invention is not limited thereto, although the exemplary embodiments can be construed as including all modifications, equivalents, or substitutes in a technical concept and a technical scope of the present invention. The similar reference numerals refer to the same or similar functions in various aspects. In the drawings, the shapes and dimensions of elements may be exaggerated for clarity. In the following detailed description of the present invention, references are made to the accompanying drawings that show, by way of illustration, specific embodiments in which the invention may be practiced. These embodiments are described in sufficient detail to enable those skilled in the art to implement the present disclosure. Various embodiments of the present disclosure, although different, are not necessarily mutually exclusive. For example, specific features, structures, and characteristics described herein, in connection with one embodiment, may be implemented within other embodiments without departing from the spirit and scope of the present disclosure. In addition, it should be understood that the location or arrangement of individual elements within each disclosed embodiment may be modified without departing from the spirit and scope of the present disclosure. The following detailed description is, therefore, not to be taken in a limiting sense, and the scope of the present disclosure is defined only by the appended claims, appropriately interpreted, along with the full range of equivalents to what the claims claim.

Terms used in the specification, ‘first’, ‘second’, etc. can be used to describe various components, but the components are not to be construed as being limited to the terms. The terms are only used to differentiate one component from other components. For example, the ‘first’ component may be named the ‘second’ component without departing from the scope of the present invention, and the ‘second’ component may also be similarly named the ‘first’ component. The term ‘and/or’ includes a combination of a plurality of items or any one of a plurality of terms.

It will be understood that when am element is simply referred to as being ‘connected to’ or ‘coupled to’ another element without being ‘directly connected to’ or ‘directly coupled to’ another element in the present description, it may be ‘directly connected to’ or ‘directly coupled to’ another element or be connected to or coupled to another element, having the other element intervening therebetween. In contrast, it should be understood that when an element is referred to as being “directly coupled” or “directly connected” to another element, there are no intervening elements present.

Furthermore, constitutional parts shown in the embodiments of the present invention are independently shown so as to represent characteristic functions different from each other. Thus, it does not mean that each constitutional part is constituted in a constitutional unit of separated hardware or software. In other words, each constitutional part includes each of enumerated constitutional parts for convenience. Thus, at least two constitutional parts of each constitutional part may be combined to form one constitutional part or one constitutional part may be divided into a plurality of constitutional parts to perform each function. The embodiment where each constitutional part is combined and the embodiment where one constitutional part is divided are also included in the scope of the present invention, if not departing from, the essence of the present invention.

The terms used in the present specification are merely used to describe particular embodiments, and are not intended to limit the present invention. An expression used in the singular encompasses the expression of the plural, unless it has a clearly different meaning in the context. In the present specification, it is to be understood that terms such as “including”, “having”, etc. are intended to indicate the existence of the features, numbers, steps, actions, elements, parts, or combinations thereof disclosed in the specification, and are not intended to preclude the possibility that one or more other features, numbers, steps, actions, elements, parts, or combinations thereof may exist or may be added. In other words, when a specific element is referred to as being “included”, elements other than, the corresponding element are not excluded, but additional elements may be included in embodiments of the present invention or the scope of the present invention.

In addition, some of constituents may not be indispensable constituents performing essential functions of the present invention but be selective constituents improving only performance thereof. The present invention may be implemented by including only the indispensable constitutional parts for implementing the essence of the present invention except the constituents used in improving performance. The structure including only the indispensable constituents except the selective constituents used in improving only performance is also included in the scope of the present invention.

Hereinafter, embodiments of the present invention will be described in detail with reference to the accompanying drawings. In describing exemplary embodiments of the present invention, well-known functions or constructions will not be described in detail since they may unnecessarily obscure the understanding of the present invention. The same constituent elements in the drawings are denoted by the same reference numerals, and a repeated description of the same elements will be omitted.

Hereinafter, an image may mean a picture configuring a video, or may mean the video itself. For example, “encoding or decoding or both of an image” may mean “encoding or decoding or both of a moving picture” and may mean “encoding or decoding or both of one image among images of a moving picture.”

Hereinafter, terms “moving picture” and “video” may be used as the same meaning and be replaced with each other.

Hereinafter, a target image may be an encoding target image which is a target of encoding and/or a decoding target image which is a target of decoding. Also, a target image may be an input image inputted to an encoding apparatus, and an input image inputted to a decoding apparatus. Here, a target image may have the same meaning with the current image.

Hereinafter, terms “image”, “picture, “frame” and “screen” may be used as the same meaning and be replaced with each other.

Hereinafter, a target block may be an encoding target block which is a target of encoding and/or a decoding target block which is a target of decoding. Also, a target block may be the current block which is a target of current encoding and/or decoding. For example, terms “target block” and “current block” may be used as the same meaning and be replaced with each other.

Hereinafter, terms “block” and “unit” may be used as the same meaning and be replaced with each other. Or a “block” may represent a specific unit.

Hereinafter, terms “region” and “segment” may be replaced with each other.

Hereinafter, a specific signal may be a signal representing a specific block. For example, an original signal may be a signal representing a target block. A prediction signal may be a signal representing a prediction block. A residual signal may be a signal representing a residual block.

In embodiments, each of specific information, data, flag, index, element and attribute, etc. may have a value. A value of information, data, flag, index, element and attribute equal to “0” may represent a logical false or the first predefined value. In other words, a value “0”, a false, a logical false and the first predefined value may be replaced with each other. A value of information, data, flag, index, element and attribute equal to “1” may represent a logical true or the second predefined value. In other words, a value “1”, a true, a logical true and the second predefined value may be replaced with each other.

When a variable i or j is used for representing a column, a row or an index, a value of i may be an integer equal to or greater than 0, or equal to or greater than 1. That is, the column, the row, the index, etc. may be counted from 0 or may be counted from 1.

### Description of Terms

Encoder: means an apparatus performing encoding. That is, means an encoding apparatus.

Decoder: means an apparatus performing decoding. That is, means a decoding apparatus.

Block: is an M×N array of a sample. Herein, M and N may mean positive integers, and the block may mean a sample array of a two-dimensional form. The block may refer to a unit. A current block my mean an encoding target block that becomes a target when encoding, or a decoding target block that becomes a target when decoding. In addition, the current block may be at least one of an encode block, a prediction block, a residual block, and a transform block.

Sample: is a basic unit, constituting a block. It may be expressed as a value from 0 to 2Bd−1 according to a bit depth (Bd). In the present invention, the sample may be used as a meaning of a pixel. That is, a sample, a pel, a pixel may nave the same meaning with each other.

Unit: may refer to an encoding and decoding unit. When encoding and decoding an image, the unit may be a region generated by partitioning a single image. In addition, the unit may mean a subdivided unit when a single image is partitioned into subdivided units during encoding or decoding. That is, an image may be partitioned into a plurality of units. When encoding and decoding an image, a predetermined process for each unit may be performed. A single unit may be partitioned into sub-units that have sizes smaller than the size of the unit. Depending on functions, the unit may mean a block, a macroblock, a coding tree unit, a code tree block, a coding unit, a coding block, a prediction unit, a prediction block, a residual unit, a residual block, a transform unit, a transform block, etc. In addition, in order to distinguish a unit from a block, the unit may include a luma component block, a chroma component block associated with the luma component block, and a syntax element of each color component block. The unit may have various sizes and forms, and particularly, the form of the unit may be a two-dimensional geometrical figure such as a square shape, a rectangular shape, a trapezoid shape, a triangular shape, a pentagonal shape, etc. In addition, unit information may include at least one of a unit type indicating the coding unit, the prediction unit, the transform unit, etc., and a unit size, a unit depth, a sequence of encoding and decoding of a unit, etc.

Coding Tree Unit: is configured with a single coding tree block of a luma component Y, and two coding tree blocks related to chroma components Cb and Cr. In addition, it may mean that including the blocks and a syntax element of each block. Each coding tree unit may be partitioned by using at least one of a quad-tree partitioning method, a binary-tree partitioning method and ternary-tree partitioning method to configure a lower unit such as coding unit, prediction unit, transform unit, etc. It may be used as a term for designating a sample block that becomes a process unit when encoding/decoding an image as an input image. Here, the quad-tree may mean a quarternary-tree.

When the size of the coding block is within a predetermined range, the division is possible using only quad-tree partitioning. Here, the predetermined range may be defined as at least one of a maximum size and a minimum size of a coding block in which the division is possible using only quad-tree partitioning. Information indicating a maximum/minimum size of a coding block in which quad-tree partitioning is allowed may be signaled through a bitstream, and the information may be signaled in at least one unit of a sequence, a picture parameter, a tile group, or a slice (segment). Alternatively, the maximum/minimum size of the coding block may be a fixed size predetermined in the coder/decoder. For example, when the size of the coding block corresponds to 256×256 to 64×64, the division is possible only using quad-tree partitioning. Alternatively, when the size of the coding block is larger than the size of the maximum conversion block, the division is possible only using quad-tree partitioning. Herein, the block to be divided may be at least one of coding blocks and a transform block. In this case, information indicating the division of the coded block (for example, split flag) may be a flag indicating whether or not to perform the quad-tree partitioning. When the size of the coding block falls within a predetermined range, the division is possible only using binary tree or ternary tree partitioning. In this case, the above description of the quad-tree partitioning may be applied to binary tree partitioning or ternary tree; partitioning in the same manner.

Coding Tree Block: may be used as a term for designating any one of a Y coding tree block, Cb coding tree block, and Cr coding tree block.

Neighbor Block: may mean a block adjacent to a current block. The block adjacent to the current block may mean a block that comes into contact with a boundary of the current block, or a block positioned within a predetermined distance from the current block. The neighbor block may mean a block adjacent to a vertex of the current block. Herein, the block adjacent to the vertex of the current block may mean a block vertically adjacent to a neighbor block that is horizontally adjacent to the current block, or a block horizontally adjacent to a neighbor block that is vertically adjacent to the current block.

Reconstructed Neighbor block: may mean a neighbor block adjacent to a current block and which has been already spatially/temporally encoded or decoded. Herein, the reconstructed neighbor block may mean a reconstructed neighbor unit. A reconstructed spatial neighbor block may be a block within a current picture and which has been already reconstructed through encoding or decoding or both. A reconstructed temporal neighbor block is a block at a corresponding position as the current block of the current picture within a reference image, or a neighbor block thereof.

Unit Depth: may mean a partitioned degree of a unit. In a tree structure, the highest node(Root Node) may correspond to the first unit which is not partitioned. Also, the highest node may have the least depth value. In this case, the highest node may have a depth of level 0. A node having a depth of level 1 may represent a unit generated by partitioning once the first unit. A node having a depth of level 2 may represent a unit generated by partitioning twice the first unit. A node having a depth of level n may represent a unit generated by partitioning n-times the first unit. A Leaf Node may be the lowest node and a node which cannot be partitioned further. A depth of a Leaf Node may be the maximum level. For example, a predefined value of the maximum level may be 3. A depth of a root node may be the lowest and a depth of a leaf node may be the deepest. In addition, when a unit is expressed as a tree structure, a level in which a unit is present may mean a unit depth.

Bitstream: may mean a bitstream including encoding image information.

Parameter Set: corresponds to header information among a configuration within a bitstream. At least one of a video parameter set, a sequence parameter set, a picture parameter set, and an adaptation parameter set may be included in a parameter set. In addition, a parameter set may include a slice header, a tile group header, and tile header information. The term “tile group” means a group of tiles and has the same meaning as a slice.

An adaptation parameter set may mean a parameter set that can be shared by being referred to in different pictures, subpictures, slices, tile groups, tiles, or bricks. In addition, information in an adaptation parameter set may be used by referring to different adaptation parameter sets for a subpicture, a slice, a tile group, a tile, or a brick inside a picture.

In addition, regarding the adaptation parameter set, different adaptation parameter sets may be referred to by using identifiers of different adaptation parameter sets for a subpicture, a slice, a tils: group, a tile, or a brick inside a picture.

In addition, regarding the adaptation parameter set, different adaptation parameter sets may be referred to by using identifiers of different adaptation parameter sets for a slice, a tile group, a tile, or a brick inside a subpicture.

In addition, regarding the adaptation parameter set, different adaptation parameter seats may be referred to by using identifiers of different adaptation parameter sets for a tile or a brick inside a slice.

In addition, regarding the adaptation parameter set, different adaptation parameter sets may be referred to by using identifiers of different adaptation parameter sets for a brick inside a tile.

Information on an adaptation parameter set identifier may be included in a parameter set or a header of the subpicture, and an adaptation parameter set corresponding to the adaptation parameter set identifier may be used for the subpicture.

The information on the adaptation parameter set identifier may be included in a parameter set or a header of the tile, and an adaptation parameter set corresponding to the adaptation parameter set identifier may be used for the tile.

The information on the adaptation parameter set identifier may be included in a header of the brick, and an adaptation parameter set corresponding to the adaptation parameter set identifier may be used for the brick.

The picture may be partitioned into one or more tile rows and one or more tile columns.

The subpicture may be partitioned into one or more tile rows and one or more tile columns within a picture. The subpicture may be a region having the form of a rectangle/square within a picture and may include one or more CTUs. In addition, at least one or more tiles/bricks/slices may be included within one subpicture.

The tile may be a region having the form of a rectangle/square within a picture and may include one or more CTUs. In addition, the tile may be partitioned into one or more bricks.

The brick may mean one or more CTU rows within a tile. The tile may be partitioned into one or more bricks, and each brick may have at least one or more CTU rows. A tile that is not partitioned into two or more may mean a brick.

The slice may include one or more tiles within a picture and may include one or more bricks within a tile.

Parsing: may mean determination of a value of a syntax element by performing entropy decoding or may mean the entropy decoding itself.

Symbol: may mean at least one of a syntax element, a coding parameter, and a transform coefficient value of an encoding/decoding target unit. In addition, the symbol may mean an entropy encoding target or an entropy decoding result.

Prediction Mode: may be information indicating a mode encoded/decoded with intra prediction or a mode encoded/decoded with inter prediction.

Prediction Unit: may mean a basic unit when performing prediction such as inter-prediction, intra-prediction, inter-compensation, intra-compensation, and motion compensation. A single prediction unit may be partitioned into a plurality of partitions having a smaller size or may be partitioned into a plurality of lower prediction units. A plurality of partitions may be a basic unit in performing prediction or compensation. A partition which is generated by dividing a prediction unit may also be a prediction unit.

Prediction Unit Partition: may mean a form obtained by partitioning a prediction unit.

Reference picture list: may refer to a list including out: or more reference pictures used for inter prediction or motion compensation. There are several types of usable reference picture lists, including LC (List combined), L0 (List 0), L1 (List 1), L2 (List 2), L3 (List 3).

Inter prediction indicator: may refer to a direction of inter prediction (unidirectional prediction, bidirectional prediction, etc.) of a current block. Alternatively, it may refer to the number of reference pictures used to generate a prediction block of a current block. Alternatively, it may refer to the number of prediction blocks used at the time of performing inter prediction or motion compensation on a current block.

Prediction list utilization flag: indicates whether a prediction block is generated using at least one reference picture in a specific reference picture list. An inter prediction indicator can be derived using a prediction list utilization flag, and conversely, a prediction list utilization flag can be derived using an inter prediction indicator. For example, when the prediction list utilization flag has a first value of zero (0), it means that a reference picture in a reference picture list is not used to generate a prediction block. On the other hand, when the prediction list utilization flag has a second value of one (1), it means that a reference picture list is used to generate a prediction block.

Reference picture index: may refer to an index indicating a specific reference picture in a reference picture list.

Reference picture: may mean a reference picture which is referred to by a specific block for the purposes of inter prediction or motion compensation of the specific block. Alternatively, the reference picture may be a picture including a reference block referred to by a current block for inter prediction or motion compensation. Hereinafter, the terms “reference picture” and “reference image” have the same meaning and can be interchangeably.

Motion vector: may be a two-dimensional vector used for inter prediction or motion compensation. The motion vector may mean an offset between an encoding/decoding target block and a reference block. For example, (mvX, mvY) may represent a motion vector. Here, mvX may represent a horizontal component and mvY may represent a vertical component.

Search range: may be a two-dimensional region which is searched to retrieve a motion vector during inter prediction. For example, the size of the search range may be M×N. Here, M and N are both integers.

Motion vector candidate: may refer to a prediction candidate block or a motion vector of the prediction candidate block when predicting a motion vector. In addition, a motion vector candidate may be included in a motion vector candidate list.

Motion vector candidate list: may mean a list composed of one or more motion vector candidates.

Motion vector candidate index: may mean an indicator indicating a motion vector candidate in a motion vector candidate list. Alternatively, it may be an index of a motion vector predictor.

Motion information: may be an information including at least one of the items including a motion vector, a reference picture index, an inter prediction indicator, a prediction list utilization flag, reference picture list information, a reference picture, a motion vector candidate, a motion vector candidate index, a merge candidate, and a merge index.

Merge candidate list: may mean a list composed of one or more merge candidates.

Merge candidate: may mean a spatial merge candidate, a temporal merge candidate, a combined merge candidate, a combined bi-predictive merge candidate, or a zero-merge candidate. The merge candidate may include motion information such as a reference picture index for each list, a motion vector, a prediction list utilization flag, and an inter prediction indicator.

Merge index: may mean an indicator indicating a merge candidate in a merge candidate list. Alternatively, the merge index may indicate a block from which a merge candidate has been derived, among reconstructed blocks spatially/temporally adjacent to a current block. Alternatively, the merge index may indicate at least one motion information of a merge candidate.

Transform Unit: may mean a basic unit when performing encoding/decoding such as transform, inverse-transform, quantization, dequantization, transform coefficient encoding/decoding of a residual signal. A single transform unit may be partitioned into a plurality of lower-level transform units having a smaller size. Here, transformation/inverse-transformation may comprise at least one among the first transformation/the first inverse-transformation and the second transformation/the second inverse-transformation.

Scaling: may mean a process of multiplying a quantized level by a factor. A transform coefficient may be generated by scaling a quantized level. The scaling also may be referred to as dequantization.

Quantization Parameter: may mean a value used when generating a quantized level using a transform coefficient during quantization. The quantization parameter also may mean a value used when generating a transform coefficient by scaling a quantized level during dequantization. The quantization parameter may be a value mapped on a quantization step size.

Delta Quantization Parameter: may mean a difference value between a predicted quantization parameter and a quantization parameter of an encoding/decoding target unit.

Scan: may mean a method of sequencing coefficients within a unit, a block or a matrix. For example, changing a two-dimensional matrix of coefficients into a one-dimensional matrix may be referred to as scanning, and changing a one-dimensional matrix of coefficients into a two-dimensional matrix may be referred to as scanning or inverse scanning.

Transform. Coefficient: map mean a coefficient value generated after transform is performed in an encoder. It may mean a coefficient value generated after at least one of entropy decoding and dequantization is performed in a decoder. A quantized level obtained by quantizing a transform coefficient or a residual signal, or a quantized transform coefficient level also may fall within the meaning of the transform coefficient.

Quantized Level: may mean a value generated by quantizing a transform coefficient or a residual signal in an encoder. Alternatively, the quantized level may mean a value that is a dequantization target to undergo dequantization in a decoder. Similarly, a quantized transform coefficient level that is a result of transform and quantization also may fall within the meaning of the quantized level.

Non-zero Transform Coefficient: may mean a transform coefficient having a value other than zero, or a transform coefficient level or a quantized level having a value other than zero.

Quantization Matrix: may mean a matrix used in a quantization process or a dequantization process performed to improve subjective or objective image quality. The quantization matrix also may be referred to as a scaling list.

Quantization Matrix Coefficient: may mean each element within a quantization matrix. The quantization matrix coefficient also may be referred to as a matrix coefficient.

Default Matrix: may mean a predetermined quantization matrix preliminarily defined in an encoder or a decoder.

Non-default Matrix: may mean a quantization matrix that is not preliminarily defined in an encoder or a decoder but is signaled by a user.

Statistic Value: a statistic value for at least one among a variable, an encoding parameter, a constant value, etc. which have a computable specific value may be one or more among an average value, a sum value, a weighted average value, a weighted sum value, the minimum value, the maximum value, the most frequent value, a median value, an interpolated value of the corresponding specific values.

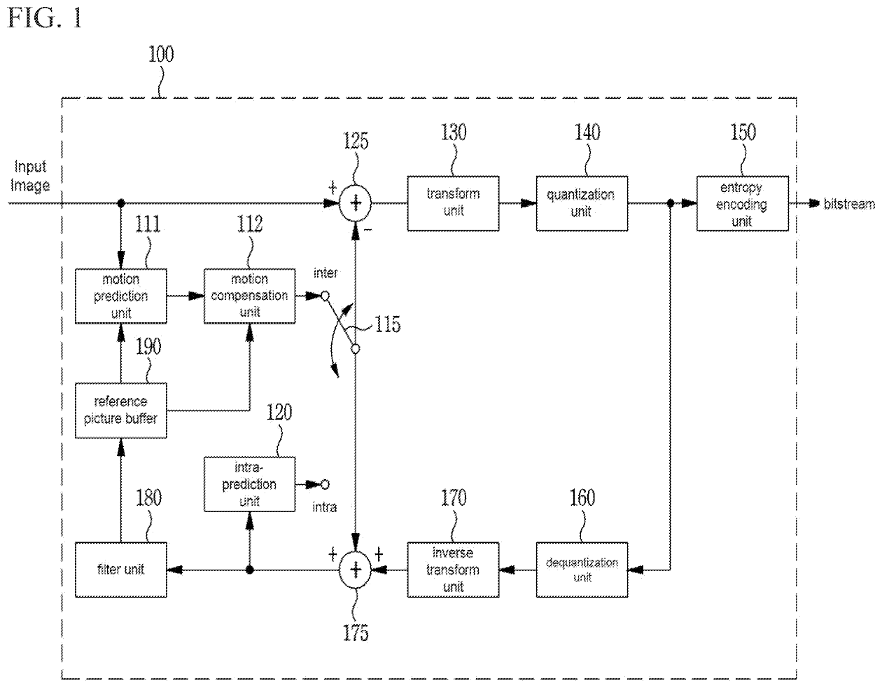

FIG. 1 is a block diagram showing a configuration of an encoding apparatus according to an embodiment to which the present invention is applied.

An encoding apparatus 100 may be an encoder, a video encoding apparatus, or an image encoding apparatus. A video may include at least one image. The encoding apparatus 100 may sequentially encode at least one image.

Referring to FIG. 1, the encoding apparatus 100 may include a motion prediction unit 111, a motion compensation unit 112, an intra-prediction unit 120, a switch 115, a subtractor 125, a transform unit 130, a quantization unit 140, an entropy encoding unit 150, a dequantization unit 160, an inverse-transform unit 170, an adder 175, a filter unit 180, and a reference picture buffer 190.

The encoding apparatus 100 may perform encoding of an input image by using an intra mode or an inter mode or both. In addition, encoding apparatus 100 may generate a bitstream including encoded information through encoding the input image, and output the generated bitstream. The generated bitstream may be stored in a computer readable recording medium, or may be streamed through a wired/wireless transmission medium. When an intra mode is used as a prediction mode, the switch 115 may be switched to an intra. Alternatively, when an inter mode is used as a prediction mode, the switch 115 may be switched to an inter. Herein, the intra mode may mean an intra-prediction mode, and the inter mode may mean an inter-prediction mode. The encoding apparatus 100 may generate a prediction block for an input block of the input image. In addition, the encoding apparatus 100 may encode a residual block using a residual of the input block and the prediction block after the prediction block being generated. The input image may be called as a current image that is a current encoding target. The input block may be called as a current block that is current encoding target, or as an encoding target block.

When a prediction mode is an intra mode, the intra-prediction unit 120 may use a sample of a block that has been already encoded/decoded and is adjacent to a current block as a reference sample. The intra-prediction unit 120 may perform, spatial prediction for the current block by using a reference sample, or generate prediction samples of an input block by performing spatial prediction. Herein, the intra prediction may mean intra-prediction,

When a prediction mode is an inter mode, the motion prediction unit 111 may retrieve a region that best matches with an input block from a reference image when performing motion prediction, and deduce a motion vector by using the retrieved region. In this case, a search region may be used as the region. The reference image may be stored in the reference picture buffer 190. Here, when encoding/decoding for the reference image is performed, it may be stored in the reference picture buffer 190.

The motion compensation unit 112 may generate a prediction block by performing motion compensation for the current block using a motion vector. Herein, inter-prediction may mean inter-prediction or motion compensation.

When the value of the motion vector is not an integer, the motion prediction unit 111 and the motion compensation unit 112 may generate the prediction block by applying an interpolation filter to a partial region of the reference picture. In order to perform inter-picture prediction or motion compensation on a coding unit, it may be determined that which mode among a skip mode, a merge mode, an advanced motion vector prediction (AMVP) mode, and a current picture referring mode is used for motion prediction and motion compensation of a prediction unit included in the corresponding coding unit. Then, inter-picture prediction or motion compensation may be differently performed depending on the determined mode.

The subtractor 125 may generate a residual block by using a difference of an input block and a prediction block. The residual block may be called as a residual signal. The residual signal may mean a difference between an original signal and a prediction signal. In addition, the residual signal may be a signal generated by transforming or quantizing, or transforming and quantizing a difference between the original signal and the prediction signal. The residual block may be a residual signal of a block unit.

The transform unit 130 may generate a transform coefficient by performing transform of a residual block, and output the generated transform coefficient. Herein, the transform coefficient may be a coefficient value generated by performing transform of the residual block. When a transform skip mode is applied, the transform unit 130 may skip transform of the residual block.

A quantized level may be generated by applying quantization to the transform coefficient or to the residual signal. Hereinafter, the quantized level may be also called as a transform coefficient in embodiments.

The quantization unit 140 may generate a quantized level by quantizing the transform coefficient or the residual signal according to a parameter, and output the generated quantized level. Herein, the quantization unit 140 may quantize the transform coefficient by using a quantization matrix.

The entropy encoding unit 150 may generate a bitstream by performing entropy encoding according to a probability distribution on values calculated by the quantization unit 140 or on coding parameter values calculated when performing encoding, and output the generated bitstream. The entropy encoding unit 150 may perform entropy encoding of sample information of an image and information for decoding an image. For example, the information for decoding the image may include a syntax element.

When entropy encoding is applied, symbols are represented so that a smaller number of bits are assigned to a symbol having a high chance of being generated and a larger number of bits are assigned to a symbol having a low chance of being generated, and thus, the size of bit stream for symbols to be encoded may be decreased. The entropy encoding unit 150 may use an encoding method for entropy encoding such as exponential Golomb, context-adaptive variable length coding (CAVLC), context-adaptive binary arithmetic coding (CABAC), etc. For example, the entropy encoding unit 150 may perform entropy encoding by using a variable length coding/code (VLC) table. In addition, the entropy encoding unit 150 may deduce a binarization method of a target symbol and a probability model of a target symbol/bin, and perform arithmetic coding by using the deduced binarization method, and a context model.

In order to encode a transform coefficient level(quantized level), the entropy encoding unit 150 may change a two-dimensional block form coefficient into a one-dimensional vector form by using a transform coefficient scanning method.

A coding parameter may include information (flag, index, etc.) such as syntax element that is encoded in an encoder and signaled to a decoder, and information derived when performing encoding or decoding. The coding parameter may mean information required when encoding or decoding an image. For example, at least one value or a combination form of a unit/block size, a unit/block depth, unit/block partition information, unit/block shape, unit/block partition structure, whether to partition of a quad-tree form, whether to partition of a binary-tree form, a partition direction of a binary-tree form (horizontal direction or vertical direction), a partition form of a binary-tree form (symmetric partition or asymmetric partition), whether or not a current coding unit is partitioned by ternary tree partitioning, direction (horizontal or vertical direction) of the ternary tree partitioning, type (symmetric or asymmetric type) of the ternary tree partitioning, whether a current coding unit is partitioned by multi-type tree partitioning, direction (horizontal or vertical direction) of the multi-type three partitioning, type (symmetric or asymmetric type) of t h e multi-type tree partitioning, and a tires: (binary tree or ternary tree) structure of the multi-type tires: partitioning, a prediction mode(intra prediction or inter prediction), a luma intra-prediction mode/direction, a chroma intra-prediction mode/direction, intra partition information, inter partition information, a coding block partition flag, a prediction block partition flag, a transform block partition flag, a reference sample filtering method, a reference sample filter tab, a reference sample filter coefficient, a prediction block filtering method, a prediction block filter tap, a prediction block filter coefficient, a prediction block boundary filtering method, a prediction block boundary filter tab, a prediction block boundary filer coefficient, an intra-prediction mode, an inter-prediction mode, motion information, a motion vector, a motion vector difference, a reference picture index, a inter-prediction angle, an inter-prediction indicator, a prediction list utilization flag, a reference picture list, a reference picture, a motion vector predictor index, a motion vector predictor candidate, a motion vector candidate list, whether to use a merge mode, a merge index, a merge candidate, a merge candidate list, whether to use a skip mode, an interpolation filter type, an interpolation filter tab, an interpolation filter coefficient, a motion vector size, a presentation accuracy of a motion vector, a transform type, a transform, size, information of whether or not a primary(first) transform is used, information of whether or not a secondary transform, is used, a primary transform index, a secondary transform index, information of whether or not a residual signal is present, a coded block pattern, a coded block flag(CBF), a quantization parameter, a quantization parameter residue, a quantization matrix, whether to apply an intra loop filter, an intra loop filter coefficient, an intra loop filter tab, an intra loop filter shape/form, whether to apply a deblocking filter, a deblocking filter coefficient, a deblocking filter tab, a deblocking filter strength, a deblocking filter shape/form, whether to apply an adaptive sample offset, an adaptive sample offset value, an adaptive sample: offset category, an adaptive sample offset type, whether to: apply an adaptive loop filter, an adaptive loop filter coefficient, an adaptive loop filter tab, an adaptive loop filter shape/form, a binarization/inverse-binarization method, a context model determining method, a context model updating method, whether to perform a regular mode, whether to perform a bypass mode, a context bin, a bypass bin, a significant coefficient flag, a last significant coefficient flag, a coded flag for a unit of a coefficient group, a position of the last significant coefficient, a flag for whether a value of a coefficient is larger than 1, a flag for whether a value of a coefficient is larger than 2, a flag for whether a value of a coefficient is larger than 3, information on a remaining coefficient value, a sign information, a reconstructed luma sample, a reconstructed chroma sample, a residual luma sample, a residual chroma-sample, a luma transform coefficient, a chroma transform coefficient, a quantized luma level, a quantized chroma level, a transform coefficient level scanning method, a size of a motion vector search area at a decoder side, a shape of a motion vector search area at a decoder side, a number of time of a motion vector search at a decoder side, information on a CTU size, information on a minimum block size, information on a maximum block size, information on a maximum block depth, information on a minimum block depth, an image displaying/output ting sequence, slice identification information, a slice type, slice partition information, tile identification information, a tile type, tile partition information, tile group identification information, a tile group type, tile group partition information, a picture type, a bit depth of an input sample, a bit depth of a reconstruction sample, a bit depth of a residual sample, a bit depth of a transform coefficient, a bit depth of a quantized level, and information on a luma signal or information on a chroma signal may be included in the coding parameter.

Herein, signaling the flag or index may mean that a corresponding flag or index is entropy encoded and included in a bitstream by an encoder, and may mean that the corresponding flag or index is entropy decoded from a bitstream by a decoder.

When the encoding apparatus 100 performs encoding through inter-prediction, an encoded current image may be used as a reference image for another image that is processed afterwards. Accordingly, the encoding apparatus 100 may reconstruct or decode the encoded current image, or store the reconstructed or decoded image as a reference image in reference picture buffer 190.

A quantized level may be dequantized in the dequantization unit 160, or may be inverse-transformed in the inverse-transform unit 170. A dequantized or inverse-transformed coefficient or both may be added with a prediction block by the adder 175. By adding the dequantized or inverse-transformed coefficient or both with the prediction block, a reconstructed block may be generated. Herein, the dequantized or inverse-transformed coefficient or both may mean a coefficient on which at least one of dequantization and inverse-transform is performed, and may mean a reconstructed residual block.

A reconstructed block may pass through the filter unit 180. The filter unit 180 may apply at least one of a deblocking filter, a sample adaptive offset (SAG), and an adaptive loop filter (ALF) to a reconstructed sample, a reconstructed block or a reconstructed image. The filter unit 180 may be called as an in-loop filter.

The deblocking filter may remove block distortion generated in boundaries between blocks. In order to determine whether or not to apply a deblocking filter, whether or not to apply a deblocking filter to a current block may be determined based samples included in several rows or columns which are included in the block. When a deblocking filter is applied to a block, another filter may be applied according to a required deblocking filtering strength.

In order to compensate an encoding error, a proper offset value may be added to a sample value by using a sample adaptive offset. The sample adaptive offset may correct an offset of a deblocked image from an original image by a sample unit. A method of partitioning samples of an image into a predetermined number of regions, determining a region to which an offset is applied, and applying the offset to the determined region, or a method of applying an offset in consideration of edge information on each sample may be used.

The adaptive loop filter may perform filtering based on a comparison result of the filtered reconstructed image and the original image. Samples included in an image may be partitioned into predetermined groups, a filter to be applied to each group may be determined, and differential filtering may be performed for each group. Information of whether or not to apply the ALF may be signaled by coding units (CUs), and a form and coefficient of the ALF to be applied to each block may vary.

The reconstructed block or the reconstructed image having passed through the filter unit 180 may be stored in the reference picture buffer 190. A reconstructed block processed by the filter unit 180 may be a part of a reference image. That is, a reference image is a reconstructed image composed of reconstructed blocks processed by the filter unit 180. The stored reference image may be used later in inter prediction or motion compensation.

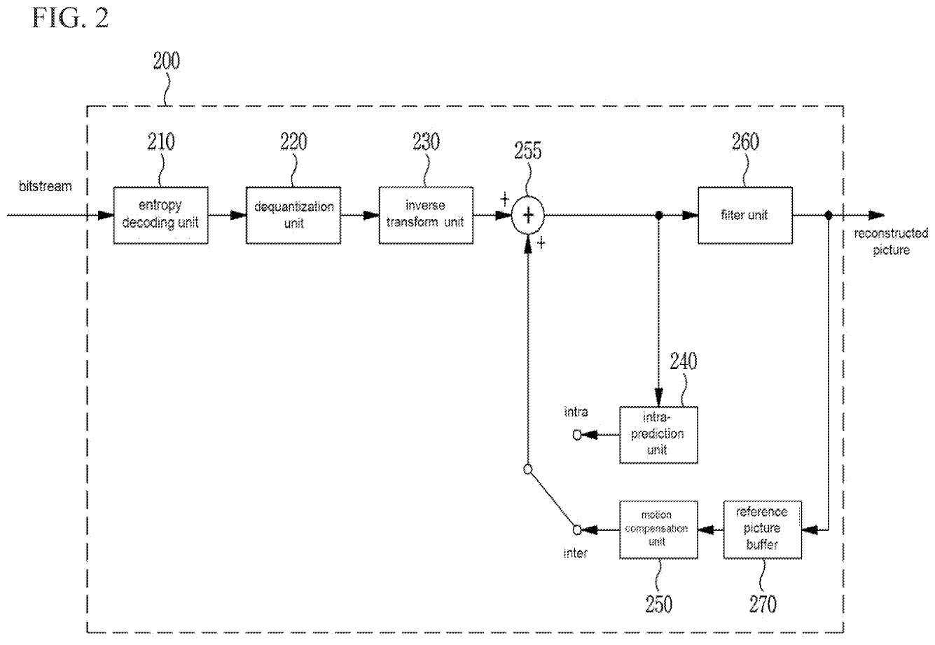

FIG. 2 is a block diagram showing a configuration of a decoding apparatus according to an embodiment and to which the present invention is applied.

A decoding apparatus 200 may a decoder, a video decoding apparatus, or an image decoding apparatus.

Referring to FIG. 2, the decoding apparatus 200 may include an entropy decoding unit 210, a dequantization unit 220, an inverse-transform unit 230, an intra-prediction unit 240, a motion compensation unit 250, an adder 225, a filter unit 260, and a reference picture buffer 270.

The decoding apparatus 200 may receive a bitstream output from the encoding apparatus 100. The decoding apparatus 200 may receive a bitstream stored in a computer readable recording medium, or may receive a bitstream that is streamed through a wired/wireless transmission medium. The decoding apparatus 200 may decode the bitstream by using an intra mode or an inter mode. In addition, the decoding apparatus 200 may generate a reconstructed image generated through decoding or a decoded image, and output the reconstructed image or decoded image.

When a prediction mode used when decoding is an intra mode, a switch may be switched to an intra. Alternatively, when a prediction mods: used when decoding is an inter mode, a switch may be switched to an inter mode.

The decoding apparatus 200 may obtain a reconstructed residual block by decoding the input bitstream, and generate a prediction block. When the reconstructed residual block and the prediction block are obtained, the decoding apparatus 200 may generate a reconstructed block that becomes a decoding target by adding the reconstructed residual block with the prediction block. The decoding target block may be called a current block.

The entropy decoding unit 210 may generate symbols by entropy decoding the bitstream according to a probability distribution. The generated symbols may include a symbol of a quantized level form. Herein, an entropy decoding method may be an inverse-process of the entropy encoding method described above.

In order to decode a transform coefficient level(quantized level), the entropy decoding unit 210 may change a one-directional vector form coefficient into a two-dimensional block form by using a transform coefficient scanning method.

A quantized level may be dequantized in the dequantization unit 220, or inverse-transformed in the inverse-transform unit 230. The quantized level may be a result of dequantizing or inverse-transforming or both, and may be generated as a reconstructed residual block. Herein, the dequantization unit 220 may apply a quantization matrix to the quantized level.

When an intra mode is used, the intra-prediction unit 240 may generate a prediction block by performing, for the current block, spatial prediction that uses a sample value of a block adjacent to a decoding target block and which has been already decoded.

When an inter mode is used, the motion compensation unit 250 may generate a prediction block by performing, for the current block, motion compensation that uses a motion vector and a reference image stored in the reference picture buffer 270.

The adder 225 may generate a reconstructed block by adding the reconstructed residual block with the prediction block. The filter unit 260 may apply at least one of a deblocking filter, a sample adaptive offset, and an adaptive loop filter to the reconstructed block or reconstructed image. The filter unit 260 may output the reconstructed image. The reconstructed block or reconstructed image may be stored in the reference picture buffer 270 and used when performing inter-prediction. A reconstructed block processed by the filter unit 260 may be a part of a reference image. That is, a reference image is a reconstructed image composed of reconstructed blocks processed by the filter unit. 260. The stored reference image may be used later in inter prediction or motion compensation.

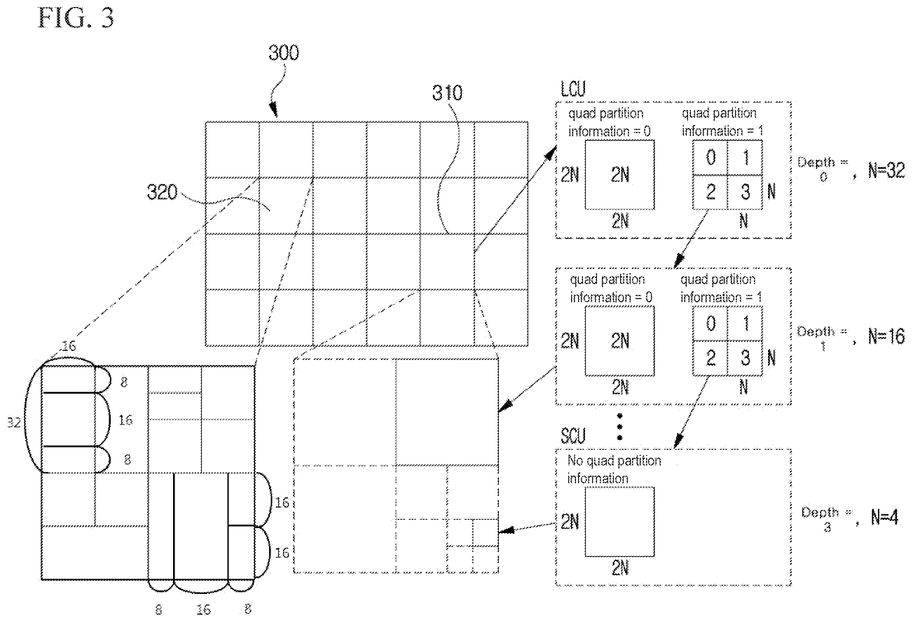

FIG. 3 is a view schematically showing a partition structure of an image when encoding and decoding the image. FIG. 3 schematically shows an example of partitioning a single unit into a plurality of lower units.

In order to efficiently partition an image, when encoding and decoding, a coding unit (CU) may be used. The coding unit may be used as a basic unit when encoding/decoding the image. In addition, the coding unit may be used as a unit for distinguishing an intra prediction mode and an inter prediction mode when encoding/decoding the image. The coding unit may be a basic unit used for prediction, transform, quantization, inverse-transform, dequantization, or an encoding/decoding process of a transform coefficient.

Referring to FIG. 3, an image 300 is sequentially partitioned in a largest coding unit (LCU), and a LCU unit is determined as a partition structure. Herein, the LCU may be used in the same meaning as a coding tree unit (CTU). A unit partitioning may mean partitioning a block associated with to the unit. In block partition information, information of a unit depth may be included. Depth information may represent a number of times or a degree or both in which a unit is partitioned. A single unit, may be partitioned into a plurality of lower level units hierarchically associated with depth information based on a tree structure. In other words, a unit and a lower level unit generated by partitioning the unit may correspond to a node and a child node of the node, respectively. Each of partitioned lower unit may have depth information. Depth information may be information representing a size of a CU, and may be stored in each CU. Unit depth represents times and/or degrees related to partitioning a unit. Therefore, partitioning information of a lower-level unit may comprise information on a size of the lower-level unit.

A partition structure may mean a distribution of a coding unit (CU) within an LCU 310. Such a distribution may be determined according to whether or not to partition a single CU into a plurality (positive integer equal to or greater than 2 including 2, 4, 8, 16, etc.) of CUs. A horizontal size and a vertical size of the CU generated by partitioning may respectively be half of a horizontal size and a vertical size of the CU before partitioning, or may respectively have sizes smaller than a horizontal size and a vertical size before partitioning according to a number of times of partitioning. The CU may be recursively partitioned into a plurality of CUs. By the recursive partitioning, at least one among a height and a width of a CU after partitioning may decrease comparing with at least one among a height and a width of a CU before partitioning. Partitioning of the CU may be recursively performed until to a predefined depth or predefined size. For example, a depth of an LCU may be 0, and a depth of a smallest coding unit (SCU) may be a predefined maximum depth. Herein, the LCU may be a coding unit having a maximum coding unit size, and the SCU may be a coding unit having a minimum coding unit size as described above. Partitioning is started from the LCU 310, a CU depth increases by 1 as a horizontal size or a vertical size or both of the CU decreases by partitioning. For example, for each depth, a CU which is not partitioned may have a size of 2N×2N. Also, in case of a CU which is partitioned, a CU with a size of 2N×2N may be partitioned into four CUs with a size of N×N. A size of N may decrease to half as a depth increase by 1.

In addition, information whether or not the CU is partitioned may be represented by using partition information of the CU. The partition information may be 1-bit information. All CUs, except for a SCU, may include partition information. For example, when a value of partition information is a first value, the CU may not be partitioned, when a value of partition information is a second value, the CU may be partitioned.

Referring to FIG. 3, an LCU having a depth 0 may be a 64×64 block. 0 may be a minimum depth. A SCU having a depth 3 may be an 8×8 block. 3 may be a maximum depth, A CU of a 32×32 block and a 16×16 block may be respectively represented as a depth 1 and a depth 2.

For example, when a single coding unit is partitioned into four coding units, a horizontal size and a vertical size of the four partitioned coding units may be a half size of a horizontal and vertical size of the CU before being partitioned. In one embodiment, when a coding unit having a 32×32 size is partitioned into four coding units, each of the four partitioned coding units may have a 16×16 size. When a single coding unit is partitioned into four coding units, it may be called that the coding unit, may be partitioned into a quad-tree form.

For example, when one coding unit is partitioned into two sub-coding units, the horizontal or vertical size (width or height) of each of the two sub-coding units may be half the horizontal or vertical size of the original coding unit. For example, when a coding unit having a size of 32×32 is vertically partitioned into two sub-coding units, each of the two sub-coding units may have a size of 16×32. For ex ampule, when a coding unit having a size of 8×32 is horizontally partitioned into two sub-coding units, each of the two sub-coding units may have a size of 8×16. When one coding unit is partitioned into two sub-coding units, it can be said that the coding unit is binary-partitioned or is partitioned by a binary tree partition structure.

For example, when one coding unit is partitioned into three sub-coding units, the horizontal or vertical size of the coding unit can be partitioned with a ratio of 1:2:1, thereby producing three sub-coding units whose horizontal or vertical sizes are in a ratio of 1:2:1. For example, when a coding unit having a size of 16×32 is horizontally partitioned into three sub-coding units, the three sub-coding units may have sizes of 16×8, 16×16, and 16×S respectively, in the order from the uppermost to the lowermost sub-coding unit. For example, when a coding unit having a size of 32×32 is vertically split into three sub-coding units, the three sub-coding units may have sizes of 8×32, 16×32, and 8×32, respectively in the order from the left to the right sub-coding unit. When one coding unit is partitioned into three sub-coding units, it can be said that the coding unit is ternary-partitioned or partitioned by a ternary tree partition structure.

In FIG. 3, a coding tree unit (CTU) 320 is an example of a CTU to which a quad tree partition structure, a binary tree partition structure, and a ternary tree partition structure are all applied.

As described above, in order to partition the CTU, at least one of a quad tree partition structure, a binary tree partition structure, and a ternary tree partition structure may be applied. Various tree partition structures may be sequentially applied to the CTU, according to a predetermined priority order. For example, the quad tree partition structure may be preferentially applied to the CTU. A coding unit that cannot be partitioned any longer using a quad tree partition structure may correspond to a leaf node of a quad tree. A coding unit corresponding to a leaf node of a quad tree may serve as a root node of a binary and/or ternary tree partition structure. That is, a coding unit corresponding to a leaf node of a quad tree may be further partitioned by a binary tree partition structure or a ternary tree partition structure, or may not be further partitioned. Therefore, by preventing a coding block that results from binary tree partitioning or ternary tree partitioning of a coding unit corresponding to a leaf node of a quad tree from undergoing further quad tree partitioning, block partitioning and/or signaling of partition information can be effectively performed.

The fact that a coding unit corresponding to a nods: of a quad tree is partitioned may be signaled using quad partition information. The quad partition information having a first value (e.g., “1”) may indicate that a current coding unit is partitioned by the quad tree partition structure. The quad partition information having a second value (e.g., “0”) may indicate that a current coding unit is not partitioned by the quad tree partition structure. The quad partition information may be a flag having a predetermined length (e.g., one bit).

There may not be a priority between the binary tree partitioning and the ternary tree partitioning. That is, a coding unit corresponding to a leaf node of a quad tree may further undergo arbitrary partitioning among the binary tree partitioning and the ternary tree partitioning. In addition, a coding unit generated through the binary tree partitioning or the ternary tree partitioning may undergo a further binary tree partitioning or a further ternary tree partitioning, or may not be further partitioned.

A tree structure in which there is no priority among the binary tree partitioning and the ternary tree partitioning is referred to as a multi-type tree structure. A coding unit corresponding to a leaf node of a quad tree may serve as a root node of a multi-type tree. Whether to partition a coding unit which corresponds to a node of a multi-type tree may be signaled using at least one of multi-type tree partition indication information, partition direction information, and partition tree information. For partitioning of a coding unit corresponding to a node of a multi-type tree, the multi-type tree partition indication information, the partition direction information, and the partition tree information may be sequentially signaled.

The multi-type tree partition indication information having a first value (e.g., “1”) may indicate that a current coding unit is to undergo a multi-type tree partitioning. The multi-type tree partition indication information having a second value (e.g., “0”) may indicate that a current coding unit is not to undergo a multi-type tree partitioning.

When a coding unit corresponding to a node of a multi-type tree is further partitioned by a multi-type tree partition structure, the coding unit, may include partition direction information. The partition direction information may indicate in which direction a current coding unit is to be partitioned for the multi-type tree partitioning. The partition direction information having a first value {e.g., “1” } may indicate that a current coding unit is to be vertically partitioned. The partition direction information having a second value (e.g., “0”) may indicate that a current coding unit is to be horizontally partitioned.

When a coding unit corresponding to a node of a multi-type tree is further partitioned by a multi-type tree partition structure, the current coding unit may include partition tree information. The partition tree information may indicate a tree partition structure which is to be used for partitioning of a node of a multi-type tree. The partition tree information having a first value (e.g., “1”) may indicate that a current coding unit is to be partitioned by a binary tree partition structure. The partition tree information having a second value (e.g., “0”) may indicate that a current coding unit is to be partitioned by a ternary tree partition structure.

The partition indication information, the partition tree information, and the partition direction information may each be a flag having a predetermined length (e.g., one bit).

At least any one of the quadtree partition indication information, the multi-type tree partition indication information, the partition direction information, and the partition tree information may be entropy encoded/decoded. For the entropy-encoding/decoding of those types of information, information on a neighboring coding unit adjacent to the current coding unit may be used. For example, there is a high probability that the partition type (the partitioned or non-partitioned, the partition tree, and/or the partition direction) of a left neighboring coding unit and/or an upper neighboring coding unit of a current coding unit is similar to that of the current coding unit. Therefore, context information for entropy encoding/decoding of the information on the current coding unit may be derived from the information on the neighboring coding units. The information on the neighboring coding units may include at least any one of quad partition information, multi-type tree partition indication information, partition direction information, and partition tree information.

As another example, among binary tree partitioning and ternary tree partitioning, binary tree partitioning may be preferentially performed. That is, a current coding unit may primarily undergo binary tree partitioning, and then a coding unit corresponding to a leaf node of a binary tree may be set as a root node for ternary tree partitioning. In this case, neither quad tree partitioning nor binary tree partitioning may not be performed on the coding unit corresponding to a node of a ternary tree.

A coding unit that cannot be partitioned by a quad tree partition structure, a binary tree partition structure, and/or a ternary tree partition structure becomes a basic unit for coding, prediction and/or transformation. That is, the coding unit cannot be further partitioned for prediction and/or transformation. Therefore, the partition structure information and the partition information used for partitioning a coding unit into prediction units and/or transformation units may not be present in a bit stream.

However, when the size of a coding unit (i.e., a basic unit for partitioning) is larger than the size of a maximum transformation block, the coding unit may be recursively partitioned until the size of the coding unit is reduced to be equal to or smaller than the size of the maximum transformation block. For example, when the size of a coding unit is 64×64 and when the size of a maximum transformation block is 32×32, the coding unit may be partitioned into four 32×32 blocks for transformation. For example, when the size of a coding unit is 32×64 and the size of a maximum transformation block is 32×32, the coding unit may be partitioned into two 32×32 blocks for the transformation. In this case, the partitioning of the coding unit for transformation is not signaled separately, and may be determined through comparison between the horizontal or vertical size of the coding unit and the horizontal or vertical size of the maximum transformation block. For example, when the horizontal size (width) of the coding unit is larger than the horizontal size (width) of the maximum transformation block, the coding unit may be vertically bisected. For example, when the vertical size (length) of the coding unit is larger than the vertical size (length) of the maximum transformation block, the coding unit may be horizontally bisected.

Information of the maximum and/or minimum size of the coding unit and information of the maximum and/or minimum size of the transformation block may be signaled or determined at an upper level of the coding unit. The upper level may be, for example, a sequence level, a picture level, a slice level, a tile group level, a tile level, or the like. For example, the minimum size of the coding unit may be determined to be 4×4. For example, the maximum size of the transformation block may be determined to be 64×64. For example, the minimum size of the transformation block may be determined to be 4×4.

Information of the minimum size (quad tree minimum size) of a coding unit corresponding to a leaf node of a quad tree and/or information of the maximum depth (the maximum tree depth of a multi-type tree) from a root node to a leaf node of the multi-type tree may be signaled or determined at an upper level of the coding unit. For example, the upper level may be a sequence level, a picture level, a slice level, a tile group level, a tile level, or the like. Information of the minimum size of a quad tree and/or information of the maximum depth of a multi-type tree may be signaled or determined for each of an intra-picture slice and an inter-picture slice.

Difference information between the size of a CTU and the maximum size of a transformation block may be signaled or determined at an upper level of the coding unit. For example, the upper level may be a sequence level, a picture level, a slice level, a tile group level, a tile level, or the like. Information of the maximum size of the coding units corresponding to the respective nodes of a binary tree (hereinafter, referred to as a maximum size of a binary tree) may be determined based on the size of the coding tree unit and the difference information. The maximum size of the coding units corresponding to the respective nodes of a ternary tree (hereinafter, referred to as a maximum size of a ternary tree) may vary depending on the type of slice. For example, for an intra-picture slice, the maximum size of a ternary tree may be 32×32. For example, for an inter-picture slice, the maximum size of a ternary tree may be 128×128. For example, the minimum size of the coding units corresponding to the respective nodes of a binary tree (hereinafter, referred to as a minimum size of a binary tree) and/or the minimum size of the coding units corresponding to the respective nodes of a ternary tree (hereinafter, referred to as a minimum size of a ternary tree) may be set as the minimum size of a coding block.

As another example, the maximum size of a binary tree and/or the maximum size of a ternary tree may be signaled or determined at the slice level. Alternatively, the minimum size of the binary tree and/or the minimum, size of the ternary tree may be signaled or determined at the slice level.

Depending on size and depth information of the above-described various blocks, quad partition information, multi-type tree partition indication information, partition tree information and/or partition direction information may be included or may not be included in a bit stream.

For example, when the size of the coding unit is not larger than the minimum size of a quad tree, the coding unit does not contain quad partition information. Thus, the quad partition information may be deduced from, a second value.

For example, when the sizes (horizontal and vertical sizes) of a coding unit corresponding to a node of a multi-type tree are larger than the maximum sizes (horizontal and vertical sizes) of a binary tree and/or the maximum sizes (horizontal and vertical sizes) of a ternary tree, the coding unit may not be binary-partitioned or ternary-partitioned. Accordingly, the multi-type tree partition indication information may not be signaled but may be deduced from a second value.

Alternatively, when the sizes (horizontal and vertical sizes) of a coding unit corresponding to a node of a multi-type tree are the same as the maximum sizes (horizontal and vertical sizes) of a binary tree and/or are two times as large as the maximum sizes (horizontal and vertical sizes) of a ternary tree, the coding unit may not be further binary-partitioned or ternary-partitioned. Accordingly, the multi-type tree partition indication information may not be signaled but be derived from a second value. This is because when a coding unit is partitioned by a binary tree partition structure and/or a ternary tree partition structure, a coding unit smaller than the minimum size of a binary tree and/or the minimum size of a ternary tree is generated.

Alternatively, the binary tree partitioning or the ternary tree partitioning may be limited on the basis of the size of a virtual pipeline data unit (hereinafter, a pipeline buffer size). For example, when the coding unit is divided into sub-coding units which do not fit the pipeline buffer size by the binary tree partitioning or the ternary tree partitioning, the corresponding binary tree partitioning or ternary tree partitioning may be limited. The pipeline buffer size may be the size of the maximum transform block (e.g., 64×64). For example, when the pips: line buffer size is 64×64, the division below may be limited.
N×M (N and/or M is 128) Ternary tree partitioning for coding units
128×N (N<=64) Binary tree partitioning in horizontal direction for coding units
N×128 (N<=64) Binary tree partitioning in vertical direction for coding units

Alternatively, when the depth of a coding unit corresponding to a node of a multi-type tree is equal to the maximum depth of the multi-type tree, the coding unit may not be further binary-partitioned and/or ternary-partitioned. Accordingly, the multi-type tree partition indication information may not be signaled but may be deduced from a second value.

Alternatively, only when at least one of vertical direction binary tree partitioning, horizontal direction binary tree partitioning, vertical direction ternary tree partitioning, and horizontal direction ternary tree partitioning is possible for a coding unit corresponding to a node of a multi-type tree, the multi-type tree partition indication information may be signaled. Otherwise, the coding unit may not be binary-partitioned and/or ternary-partitioned. Accordingly, the multi-type tree partition indication information may not be signaled but may be deduced from a second value.

Alternatively, only when both of the vertical direction binary tree partitioning and the horizontal direction binary tree partitioning or both of the vertical direction ternary tree partitioning and the horizontal direction ternary tree partitioning are possible for a coding unit corresponding to a node of a multi-type tree, the partition direction information may be signaled. Otherwise, the partition direction information may not be signaled but may be derived from a value indicating possible partitioning directions.

Alternatively, only when both of the vertical direction binary tree partitioning and the vertical direction ternary tree partitioning or both of the horizontal direction binary tree partitioning and the horizontal direction ternary tree partitioning are possible for a coding tree corresponding to a node of a multi-type tree, the partition tree information may be signaled. Otherwise, the partition tree information may not be signaled but be deduced from a value indicating a possible partitioning tree structure.

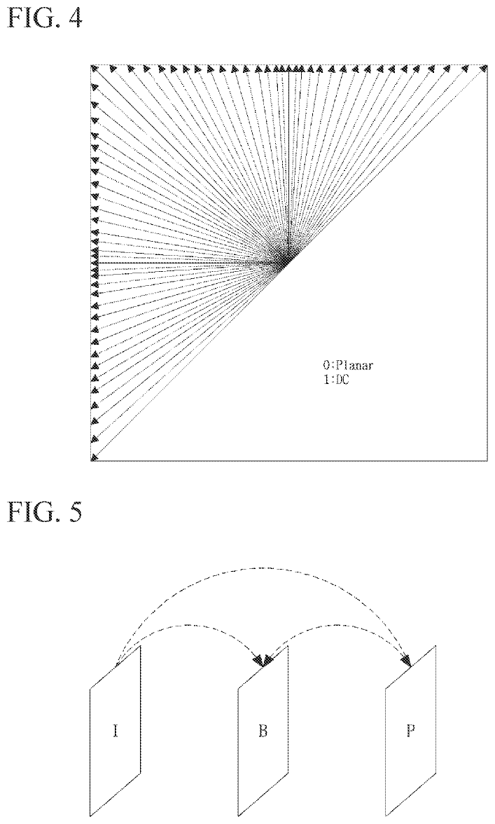

FIG. 4 is a view showing an intra-prediction process.

Arrows from center to outside in FIG. 4 may represent prediction directions of intra prediction modes.

Intra encoding and/or decoding may be performed by using a reference s ampule of a neighbor block of the current block. A neighbor block may be a reconstructed neighbor block. For example, intra encoding and/or decoding may be performed by using an encoding parameter or a value of a reference sample included in a reconstructed neighbor block.

A prediction block may mean a block generated by performing intra prediction. A prediction block may correspond to at least one among CU, PU and TU. A unit of a prediction block may have a size of one among CU, PU and TU. A prediction block may be a square block having a size of 2×2, 4×4, 16×16, 32×32 or 64×64 etc. or may be a rectangular block having a size of 2×8, 4×8, 2×16, 4×16 and 8×16 etc.

Intra prediction may be performed according to intra prediction mode for the current block. The number of intra prediction modes which the current block may have may be a fixed value and may be a value determined differently according to an attribute of a prediction block. For example, an attribute of a prediction block may comprise a size of a prediction block and a shape of a prediction block, etc.

The number of intra-prediction modes may be fixed to N regardless of a block size. Or, the number of intra prediction modes may be 3, 5, 9, 17, 34, 35, 36, 65, or 67 etc. Alternatively, the number of intra-prediction modes may vary according to a block size or a color component type or both. For example, the number of intra prediction modes may vary according to whether the color component is a luma signal or a chroma signal. For example, as a block size becomes large, a number of intra-prediction modes may increase. Alternatively, a number of intra-prediction modes of a luma component block may be larger than a number of intra-prediction modes of a chroma component block.

An intra-prediction mode may be a non-angular mode or an angular mode. The non-angular mode may be a DC mods: or a planar mode, and the angular mode may be a prediction mode having a specific direction or angle. The intra-prediction mode may be expressed by at least one of a mode number, a mode value, a mode numeral, a mode angle, and mode direction. A number of intra-prediction modes may be M, which is larger than 1, including the non-angular and the angular mode. In order to intra-predict a current block, a step of determining whether or not samples included in a reconstructed neighbor block may be used as reference samples of the current block may be performed. When a sample that is not usable as a reference sample of the current block is present, a value obtained by duplicating or performing interpolation on at least one sample value among samples included in the reconstructed neighbor block or both may be used to replace with a non-usable sample value of a samples thus the replaced sample value is used as a reference sample of the current block.

FIG. 7 is a diagram illustrating reference samples capable of being used for intra prediction.

As shown in FIG. 7, at least one of the reference sample line 0 to the reference sample line 3 may be used for intra prediction of the current block. In FIG. 7, the samples of a segment A and a segment F may be padded with the samples closest to a segment B and a segment E, respectively, instead of retrieving from the reconstructed neighboring block. Index information indicating the reference sample line to be used for intra prediction of the current block may be signaled. When the upper boundary of the current block is the boundary of the CTU, only the reference sample line 0 may be available. Therefore, in this case, the index information may not be signaled. When a reference sample line other than the reference sample line 0 is used, filtering for a prediction block, which will be described later, may not be performed.

When intra-predicting, a filter may be applied to at least one of a reference sample and a prediction sample based on an intra-prediction mode and a current block size.

In case of a planar mode, when generating a prediction block of a current block, according to a position of a prediction target sample within a prediction block, a sample value of the prediction target sample may be generated by using a weighted sum of an upper and left side reference sample of a current sample, and a right upper side and left lower side reference sample of the current block. In addition, in case of a DC mode, when generating a prediction block of a current block, an average value of upper side and left side reference samples of the current block may be used. In addition, in case of an angular mode, a prediction block may be generated by using an upper side, a left side, a right upper side, and/or a left lower side reference sample of the current block. In order to generate a prediction sample value, interpolation of a real number unit may be performed.

In the case of intra prediction between color components, a prediction block for the current block of the second color component may be generated on the basis of the corresponding reconstructed block of the first color component. For example, the first color component may be a luma component, and the second color component may be a chroma component. For intra prediction between color components, the parameters of the linear model between the first color component and the second color component may be derived on the basis of the template. The template may include upper and/or left neighboring samples of the current block and upper and/or left neighboring samples of the reconstructed block of the first color component corresponding thereto. For example, the parameters of the linear model may be derived using a sample value of a first color component having a maximum value among samples in a template and a sample value of a second color component corresponding thereto, and a sample value of a first color component having a minimum value among samples in the template and a sample value of a second color component corresponding thereto. When the parameters of the linear model are derived, a corresponding reconstructed block may be applied to the linear model to generate a prediction block for the current block. According to a video format, subsampling may be performed on the neighboring samples of the reconstructed block of the first, color component and the corresponding reconstructed block. For example, when one sample of the second color component corresponds to four samples of the first color component, four samples of the first color component may be sub-sampled to compute one corresponding sample. In this case, the parameter derivation of the linear model and intra prediction between color components may be performed on the basis of the corresponding sub-sampled samples. Whether or not to perform intra prediction between color components and/or the range of the template may be signaled as the intra prediction mode.

The current block may be partitioned into two or four sub-blocks in the horizontal or vertical direction. The partitioned sub-blocks may be sequentially reconstructed. That is, the intra prediction may be performed on the sub-block to generate the sub-prediction block. In addition, dequantization and/or inverse transform may be performed on the sub-blocks to generate sub-residual blocks. A reconstructed sub-block may be generated by adding the sub-prediction block to the sub-residual block. The reconstructed sub-block may be used as a reference sample for intra prediction of the sub-sub-blocks. The sub-block may be a block including a predetermined number (for example, 16) or more samples. Accordingly, for example, when the current block is an 8×4 block or a 4×8 block, the current block may be partitioned into two sub-blocks. Also, when the current block is a 4×4 block, the current block may not be partitioned into sub-blocks. When the current block has other sizes, the current block may be partitioned into four sub-blocks. Information on whether or not to perform the intra prediction based on the sub-blocks and/or the partitioning direction (horizontal or vertical) may be signaled. The intra prediction based on the sub-blocks may be limited to be performed only when reference sample line 0 is used. When the intra prediction based on the sub-block is performed, filtering for the prediction block, which will be described later, may not be performed.

The final prediction lock may be generated by performing filtering on the prediction block that is intra-predicted. The filtering may be performed by applying predetermined weights to the filtering target sample, the left reference sample, the upper reference sample, and/or the upper left reference sample. The weight and/or the reference sample (range, position, etc.) used for the filtering may be determined on the basis of at least one of a block size, an intra prediction mode, and a position of the filtering target sample in the prediction block. The filtering may be performed only in the case of a predetermined intra prediction mode (e.g., DC, planar, vertical, horizontal, diagonal, and/or adjacent diagonal modes). The adjacent diagonal mode may be a mode in which k is added to or subtracted from the diagonal mode. For example, k may be a positive integer of 8 or less.

An intra-prediction mode of a current block may be entropy encoded/decoded by predicting an intra-prediction mode of a block present adjacent to the current block. When intra-prediction modes of the current block and the neighbor block are identical, information that the intra-prediction modes of the current block and the neighbor block are identical may be signaled by using predetermined flag information. In addition, indicator information of an intra-prediction mode that is identical to the intra-prediction mode of the current block among intra-prediction modes of a plurality of neighbor blocks may be signaled. When intra-prediction modes of the current block and the neighbor block are different, intra-prediction mode information of the current block may be entropy encoded/decoded by performing entropy encoding/decoding based on the intra-prediction mode of the neighbor block.

FIG. 5 is a diagram illustrating an embodiment of an inter-picture prediction process.

In FIG. 5, a rectangle may represent a picture. In FIG. 5, an arrow represents a prediction direction. Pictures may be categorized into intra pictures (I pictures), predictive pictures (P pictures), and Bi-predictive pictures (B pictures) according to the encoding type thereof.

The I picture may be encoded through intra-prediction without requiring inter-picture prediction. The P picture may be encoded through inter-picture prediction by using a reference picture that is present in one direction (i.e. f forward direction or backward direction) with respect to a current block. The B picture may be encoded through inter-picture prediction by using reference pictures that are present in two directions (i.e., forward direction and backward direction) with respect to a current block. When the inter-picture prediction is used, the encoder may perform inter-picture prediction or motion compensation and the decoder may perform the corresponding motion compensation.

Hereinbelow, an embodiment of the inter-picture prediction will be described in detail.

The inter-picture prediction or motion compensation may be performed using a reference picture and motion information.

Motion information of a current block may be derived during inter-picture prediction by each of the encoding apparatus 100 and the decoding apparatus 200. The motion information of the current block may be derived by using motion information of a reconstructed neighboring block, motion information of a collocated block (also referred to as a col block or a co-located block), and/or a block adjacent to the co-located block. The co-located block may mean a block that is located spatially at the same position as the current block, within a previously reconstructed collocated picture (also referred to as a col picture or a co-located picture). The co-located picture may be one picture among one or more reference pictures included in a reference picture list.

The derivation method of the motion information may be different depending on the prediction mode of the current block. For example, a prediction mode applied for inter prediction includes an AMVP mode, a merge mode, a skip mode, a merge mode with a motion vector difference, a subblock merge mode, a triangle partition mode, an inter-intra combination prediction mode, affine mode, and the like. Herein, the merge mode may be referred to as a motion merge mode.

For example, when the AMVP is used as the prediction mode, at least one of motion vectors of the reconstructed neighboring blocks, motion vectors of the co-located blocks, motion vectors of blocks adjacent to the co-located blocks, and a (0, 0) motion vector may be determined as motion vector candidates for the current block, and a motion vector candidate list is generated by using the motion vector candidates. The motion vector candidate of the current block can be derived by using the generated motion vector candidate list. The motion information of the current block may be determined based on the derived motion vector candidate. The motion vectors of the collocated blocks or the motion vectors of the blocks adjacent to the collocated blocks may be referred to as temporal motion vector candidates, and the motion vectors of the reconstructed neighboring blocks may be referred to as spatial motion vector candidates.

The encoding apparatus 100 may calculate a motion vector difference (MVD) between the motion vector of the current block and the motion vector candidate and may perform entropy encoding on the motion vector difference (MVD). In addition, the encoding apparatus 100 may perform entropy encoding on a motion vector candidate index and generate a bitstream. The motion vector candidate index may indicate an optimum motion vector candidate among the motion vector candidates included in the motion vector candidate list. The decoding apparatus may perform entropy decoding on the motion vector candidate index included in the bitstream and may select a motion vector candidate of a decoding target block from among the motion vector candidates included in the motion vector candidate list by using the entropy-decoded motion vector candidate index. In addition, the decoding apparatus 200 may add the entropy-decoded MVD and the motion vector candidate extracted through the entropy decoding, thereby deriving the motion vector of the decoding target block.

Meanwhile, the coding apparatus 100 may perform entropy-coding on resolution information of the calculated MVD. The decoding apparatus 200 may adjust the resolution of the entropy-decoded MVD using the MVD resolution information.

Meanwhile, the coding apparatus 100 calculates a motion vector difference (MVD) between a motion vector and a motion vector candidate in the current block on the basis of an affine model, and performs entropy-coding on the MVD. The decoding apparatus 200 derives a motion vector on a per sab-block basis by deriving an affine control motion vector of a decoding target block through the sum of the entropy-decoded MVD and an affine control motion vector candidate.

The bitstream may include a reference picture index indicating a reference picture. The reference picture index may be entropy-encoded by the encoding apparatus 100 and then signaled as a bitstream to the decoding apparatus 200. The decoding apparatus 200 may generate a prediction block of the decoding target block based on the derived motion vector and the reference picture index information.

Another example of the method of deriving the motion information of the current block may be the merge mode. The merge mode may mean a method of merging motion of a plurality of blocks. The merge mode may mean a mode of deriving the motion information of the current block from the motion information of the neighboring blocks. When the merge mode is applied, the merge candidate list may be generated using the motion information of the reconstructed neighboring blocks and/or the motion information erf the collocated blocks. The motion information may include at least one of a motion vector, a reference picture index, and an inter-picture prediction indicator. The prediction indicator may indicate one-direction prediction (L0 prediction or L1 prediction) or two-direction predictions (L0 prediction and L1 prediction).

The merge candidate list may be a list of motion information stored. The motion information included in the merge candidate list may be at least one of motion information (spatial merge candidate) of a neighboring block adjacent to the current block, motion information (temporal merge candidate) of the collocated block of the current block in the reference picture, new motion information generated by a combination of the motion information existing in the merge candidate list, motion information (history-based merge candidate) of the block that is encoded/decoded before the current block, and zero merge candidate.

The encoding apparatus 100 may generate a bitstream by performing entropy encoding on at least one of a merge flag and a merge index and may signal the bitstream to the decoding apparatus 200. The merge flag may be information indicating whether or not to perform the merge mode for each block, and the merge index may be information indicating that which neighboring block, among the neighboring blocks of the current block, is a merge target block. For example, the neighboring blocks of the current block may include a left, neighboring block on the left side of the current block, an upper neighboring block disposed above the current block, and a temporal neighboring block temporally adjacent to the current block.

Meanwhile, the coding apparatus 100 performs entropy-coding on the correction information for correcting the motion vector among the motion information of the merge candidate and signals the same to the decoding apparatus 200. The decoding apparatus 200 can correct the motion vector of the merge candidate selected by the merge index on the basis of the correction information. Here, the correction information may include at least one of information on whether or not to perform the correction, correction direction information, and correction size information. As described above, the prediction mode that corrects the motion vector of the merge candidate on the basis of the signaled correction information may be referred to as a merge mode having the motion vector difference.

The skip mode may be a mode in which the motion information of the neighboring block is applied to the current block as it is. When the skip mode is applied, the encoding apparatus 100 may perform entropy encoding on information of the fact that the motion information of which block is to be used as the motion information of the current block to generate a bit stream, and may signal the bitstream to the decoding apparatus 200. The encoding apparatus 100 may not signal a syntax element regarding at least any one of the motion vector difference information, the encoding block flag, and the transform coefficient level to the decoding apparatus 200.

The subblock merge mode may mean a mode that derives the motion information in units of sub-blocks of a coding block (CU). When the subblock merge mode is applied, a subblock merge candidate list may be generated using motion information (sub-block based temporal merge candidate) of the sub-block collocated to the current sub-block in the reference image and/or an affine control point motion vector merge candidate.

The triangle partition mode may mean a mode that derives motion information by partitioning the current block into diagonal directions, derives each prediction sample using each of the derived motion information, and derives the prediction sample of the current block by weighting each of the derived prediction samples.

The inter-intra combined prediction mode may mean a mode that derives a prediction sample of the current block by weighting a prediction sample generated by inter prediction and a prediction sample generated by intra prediction.

The decoding apparatus 200 may correct the derived motion information by itself. The decoding apparatus 200 may search the predetermined region on the basis of the reference block indicated by the derived motion information and derive the motion information having the minimum SAD as the corrected motion information.

The decoding apparatus 200 may compensate a prediction sample derived via inter prediction using an optical flow.

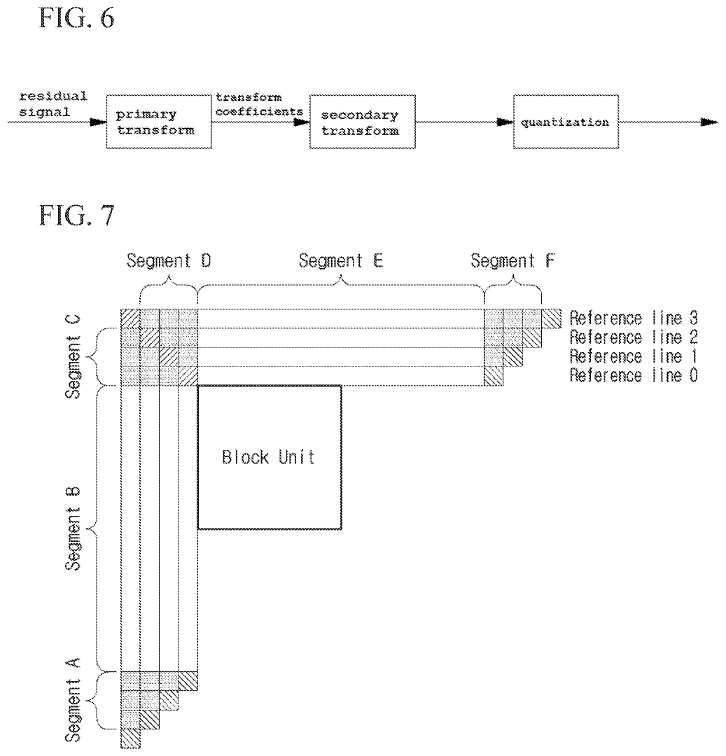

FIG. 6 is a diagram illustrating a transform and quantization process.

As illustrated in FIG. 6, a transform and/or quantization process is performed on a residual signal to generate a quantized level signal. The residual signal is a difference between an original block and a prediction block (i.e., an intra prediction block or an inter prediction block). The prediction block is a block generated through intra prediction or inter prediction. The transform may be a primary transform, a secondary transform, or both. The primary transform of the residual signal results in transform coefficients, and the secondary transform of the transform coefficients results in secondary transform coefficients.

At least one scheme selected from among various transform schemes which are preliminarily defined is used to perform the primary transform. For example, examples of the predefined transform schemes include discrete cosine transform (DCT), discrete sine transform (DST), and Karhunen-Loève transform (KLT). The transform coefficients generated through the primary transform may undergo the secondary transform. The transform schemes used for the primary transform and/or the secondary transform may be determined according to coding parameters of the current block and/or neighboring blocks of the current block. Alternatively, transform information indicating the transform scheme may be signaled. The DCT-based transform may include, for example, DCT-2, DCT-8, and the like. The DST-based transform may include, for example, DST-7.

A quantized-level signal (quantization coefficients) may be generated by performing quantization on the residual signal or a result of performing the primary transform and/or the secondary transform. The quantized level signal may be scanned according to at least one of a diagonal up-right scan, a vertical scan, and a horizontal scan, depending on an intra prediction mode of a block or a block size/shape. For example, as the coefficients are scanned in a diagonal up-right scan, the coefficients in a block form change into a one-dimensional vector form. Aside from the diagonal up-right scan, the horizontal scan of horizontally scanning a two-dimensional block form of coefficients or the vertical scan of vertically scanning a two-dimensional block form of coefficients may be used depending on the intra prediction mode and/or the size of a transform block. The scanned quantized-level coefficients may be entropy-encoded to be inserted into a bitstream.

A decoder entropy-decodes the bitstream to obtain the quantized-level coefficients. The quantized-level coefficients may be arranged in a two-dimensional block form through inverse scanning. For the inverse scanning, at least one of a diagonal up-right scan, a vertical scan, and a horizontal scan may be used.

The quantized-level coefficients may then be dequantized, then be secondary-inverse-transformed as necessary, and finally be primary-inverse-transformed as necessary to generate a reconstructed residual signal.

Inverse mapping in a dynamic range may be performed for a luma component reconstructed through intra prediction or inter prediction before in-loop filtering. The dynamic range may be divided into 16 equal pieces and the mapping function for each piece may be signaled. The mapping function may be signaled at a slice level or a tile group; level. An inverse mapping function for performing the inverse mapping may be derived on the basis of the mapping function. In-loop filtering, reference picture storage, and motion compensation are performed in an inverse mapped region, and a prediction block generated through inter prediction is converted into a mapped region via mapping using the mapping function, and then used for generating the reconstructed block. However, since the intra prediction is performed in the mapped region, the prediction block generated via the intra prediction may be used for generating the reconstructed block without mapping/inverse mapping.

When the current block is a residual block of a chroma component, the residual block may be converted into an inverse mapped region by performing scaling on the chroma component of the mapped region. The availability of the scaling may be signaled at the slice level or the tile group level. The scaling may be applied only when the mapping for the luma component is available and the division of the luma component and the division of the chroma component follow the same tree structure. The scaling may be performed on the basis of an average of sample values of a luma prediction block corresponding to the color difference block. In this case, when the current block uses inter prediction, the luma prediction block may mean a mapped luma prediction block. A value necessary for the scaling may be derived by referring to a lookup table using an index of a piece to which an average of sample values of a luma prediction block belongs. Finally, by scaling the residual block using the derived value, the residual block may be switched to the inverse mapped region. Then, chroma component block restoration, intra prediction, inter prediction, in-loop filtering, and reference picture storage may be performed in the inverse mapped area.

Information indicating whether the mapping/inverse mapping of the luma component and chroma component is available may be signaled through a set of sequence parameters.

The prediction block of the current block may be generated on the basis of a block vector indicating a displacement between the current block and the reference block in the current picture. In this way, a prediction mode for generating a prediction block with reference to the current picture is referred to as an intra block copy (IBC) mode. The IBC mode may be applied to M×N (M<=64, N<=64) coding units. The IBC mode may include a skip mode, a merge mode, an AMVP mode, and the like. In the case of a skip mode or a merge mode, a merge candidate list is constructed, and the merge index is signaled so that one merge candidate may be specified. The block vector of the specified merge candidate may be used as a block vector of the current block. The merge candidate list may include at least one of a spatial candidate, a history-based candidate, a candidate based on an average of two candidates, and a zero-merge candidate. In the case of an AMVP mode, the difference block vector may be signaled. In addition, the prediction block vector may be derived from the left neighboring block and the upper neighboring block of the current block. The index on which neighboring block to use may be signaled. The prediction block in the IBC mode is included in the current CTU or the left CTU and limited to a block in the already reconstructed area. For example, a value of the block vector may be limited such that the prediction block of the current block is positioned in an area of three 64×64 blocks preceding the 64×64 block to which the current block belongs in the coding/decoding order. By limiting the value of the block vector in this way, memory consumption and device complexity according to the IBC mode implementation may be reduced.

Hereinafter, an image decoding/encoding method will be described according to an embodiment of the present invention.

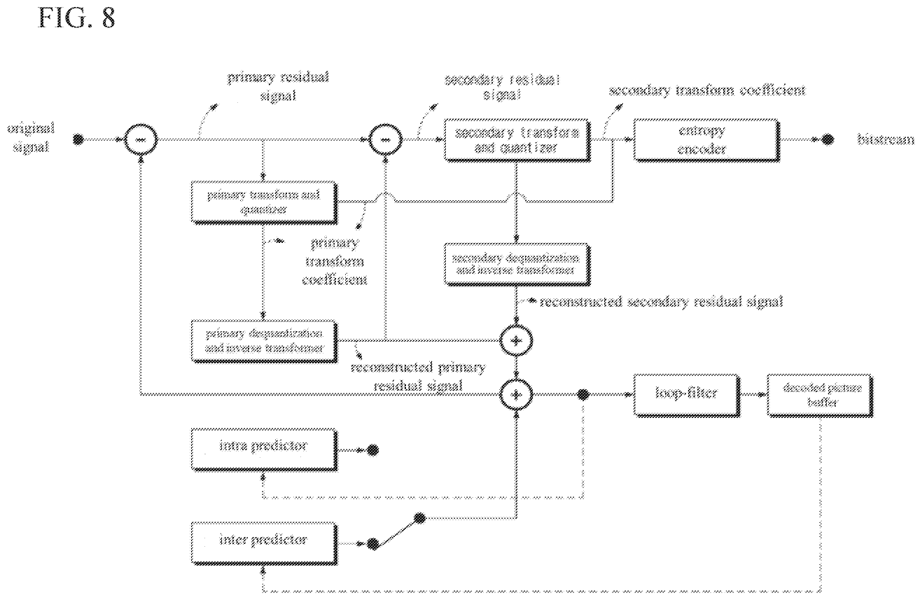

FIG. 8 is a flowchart illustrating an encoding method of an image encoding apparatus according to the present invention.

In the present invention, the primary transform and quantization may mean a primary transform, the primary dequantization and inverse transform may mean a primary inverse transform, and the secondary transform and quantization may mean a secondary transform, and secondary dequantization and inverse transform may mean a secondary inverse transform.

Further, in the present invention, the secondary transform may be sequentially performed on the primary transform coefficients generated after the primary transform, and the primary transform may be sequentially performed on the secondary transform coefficients generated after the secondary transform.

Likewise, the secondary inverse transform may be sequentially performed on the secondary transform coefficients generated after the primary inverse transform, and the primary inverse transform may be sequentially performed on the primary transform coefficient generated after the secondary inverse transform.

The two transforms may be expressed as an N-order transform/inverse transform and an M-order transform/inverse transform, respectively. Here, N and M may be 1 and 2, respectively. N and M may be 2 and 1, respectively. In other words, the transform/inverse transform is expressed in the primary and the secondary to distinguish the transform methods from each other, the primary transform/inverse transform and the secondary transform/inverse transform may be performed irrespective of the order thereof.

As shown in FIG. 8, the first subtracter may receive an original signal and a prediction signal that is an output of an intra predictor or an inter predictor, thereby outputting a primary residual signal

The primary transform and quantizer transforms the primary residual signal to generate primary transform coefficients, which may be input to the entropy encoder and the primary inverse quantization and inverse transformer.

The primary dequantization and inverse transformer may transform the input coefficients into the pixel region to output the reconstructed primary residual signal.

The second subtractor may receive the reconstructed primary residual signal and the primary residual signal and subtract two signals to output a secondary residual signal.

The secondary transform and quantizer may transform the secondary residual signal to generate a secondary transform coefficient.

The secondary transform coefficients may be input to an entropy encoder and a secondary dequantization and inverse transformer. Here, the secondary dequantization and inverse transformer may transform the input secondary transform coefficients into the pixel region to output the reconstructed secondary residual signal.

The first adder may receive the reconstructed primary residual signal and the reconstructed secondary residual signal to generate a final reconstructed residual signal.

The second adder may add the final reconstructed residual signal and the intra prediction signal or the inter pro: diet ion signal to generate reconstructed pixels.

The loop filter may perform filtering on the reconstructed pixels and then store the same into the decoded picture buffer.

The entropy encoder may receive primary transform coefficients and secondary transform coefficients and perform independent entropy encoding thereon, or perform entropy encoding in combination of one transform coefficient block. Herein, the encoding may be performed in an effective method in terms of compression efficiency by using binarization or transform coefficient scanning methods in consideration of statistical characteristics of transform coefficients.

Meanwhile, unlike the encoder of FIG. 8, as shown in FIG. 6 described above, the encoder may perform both the primary transform and the secondary transform and then perform quantization. In addition, the encoder may perform at least one of the primary transform and the secondary transform and then perform, quantization. In addition, the encoder may perform tone secondary inverse transform and the primary inverse transform after performing dequantization as described in FIG. 6. The encoder may perform at least one of the secondary inverse transform and the primary inverse transform after performing dequantization.

The encoder may optionally use a primary transform or a secondary transform.

For example, only primary transform may be used or only secondary transform may be used in any block, CTU, tile, slice, picture, or sequence unit. Alternatively, both primary and secondary transforms may be used.

Meanwhile, the encoder may select an optimal transform method by minimizing a rate-distortion cost or using a method in which a sum of absolute values of transform coefficients or the least number of frequencies is the smallest.

The encoder may transmit, to the decoder, a bitstream including information indicating whether a primary transform is performed, whether a secondary transform is performed, or whether both primary transform and secondary transform are performed, in units of block, slice, picture, or sequence.

For example, information on whether primary/transform is performed may be transmitted through coded block flag (CBF) information on the primary transform coefficient block. When the CBF is 0, this may mean that the primary transform has not been performed, and when the CBF is 1, this means that the primary transform has been performed.

For example, information on whether secondary transform is performed may be transmitted through CBF information on a secondary transform coefficient block. When the CBF is 0, this may mean that the secondary transform is not performed, and when the CBF is 1, this means that the secondary transform has been performed.

For example, when a flag indicating whether or not to perform primary transform, on a per picture basis is transmitted and the flag is 0, the primary transform may not be performed on all blocks included in the current picture.

For example, when a flag indicating whether to perform secondary transform on a per picture basis is transmitted and the flag is 0, the secondary transform may not be performed on all blocks included in the current picture.

For example, when a flag indicating whether or not to perform primary transform on a per sequence basis is transmitted and the flag is 0, the primary transform may not be performed on all blocks included in the current sequence.

For example, when a flag indicating whether or not to perform secondary transform on a per sequence basis is transmitted and the flag is 0, the secondary transform may not be performed on all blocks included in the current sequence.

The encoder may selectively use the primary transform or the secondary transform according to the component type (luminance or color difference), block size, or prediction mode of the current block.

For example, when the encoder/decoder is defined so that both the primary transform and the secondary transform are airways used when using inter prediction, information indicating whether the primary transform is used or whether the secondary transform is implicitly determined, thereby encoding the current block.

For example, when the encoder/decoder is defined so that both the primary transform and the secondary transform are always used when using intra prediction, information indicating whether the primary transform is used or whether the secondary transform is implicitly determined, thereby encoding the current block.

The primary transform coefficients are all 0 after the primary transform is performed, or the primary inverse transform may be omitted when the primary transform is omitted.

When the primary transform coefficients are all zero after the primary transform is performed, at least one arbitrary coefficient among the primary transform coefficients may be forcibly set to a non-zero value.

The secondary transform coefficients are all zero after the secondary transform is performed, or the secondary inverse transform may be omitted when the secondary transform is omitted.

When the secondary transform coefficients are all zero after the secondary transform is performed, at least one arbitrary coefficient among the secondary transform coefficients may be forcibly set to a non-zero value,

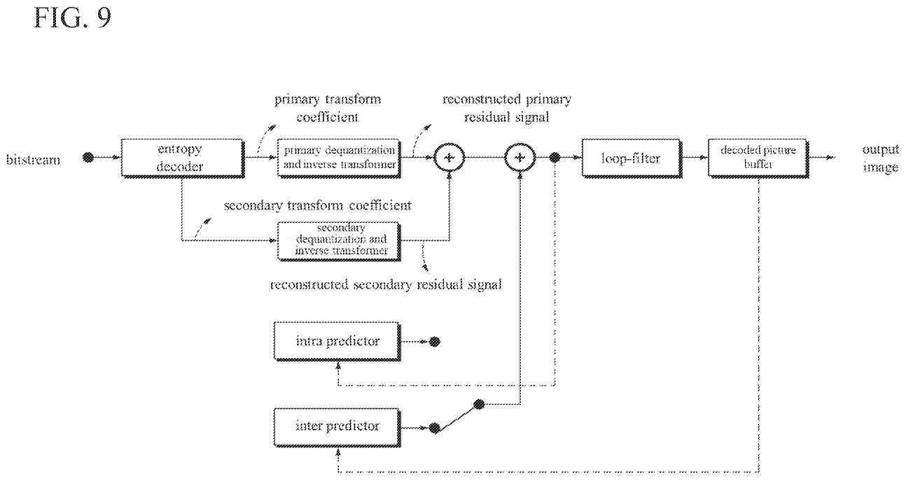

FIG. 9 is a decoding flowchart of an image decoding apparatus for the present invention.

As shown in FIG. 9, the decoding apparatus receives a bitstream and inputs the same to an entropy decoder.

The entropy decoder may decode the primary transform coefficient and/or the secondary transform coefficient for any block by using binarization or transform coefficient scanning methods in consideration of statistical characteristics of the transform coefficient. Herein, two transform coefficient blocks may be generated by performing entropy decoding on each of the primary transform coefficients and secondary transform coefficients independently encoded.

Alternatively, the combined primary transform coefficient block and secondary transform coefficient block may be decomposed into two transform coefficient blocks by performing entropy decoding on the same.

The primary dequantization and inverse transformer may transform the input primary transform coefficient into a pixel region to output the reconstructed first residual signal.

The secondary dequantization and inverse transformer may transform the input secondary transform coefficients into the pixel region to output the reconstructed secondary residual signal.

The first adder may add the reconstructed primary residual signal and the reconstructed secondary residual signal to generate one final reconstructed residual signal.

The second adder may generate reconstructed pixels by adding the final reconstructed residual signal and the prediction signal that is an output of the intra predictor or the inter predictor.

The loop filter may filter the reconstructed pixels, and the filtered pixels may be stored in a decoded picture buffer and used as a reference picture for inter-prediction or as an output image when performing decoding on the future picture.

Meanwhile, unlike the decoder of FIG. 9, as illustrated in FIG. 6 described above, the decoder may perform a second inverse transform and a first inverse transform after performing dequantization. The decoder may perform at least one of the second inverse transform and the first inverse transform after performing dequantization.

The decoder performs entropy decoding on information indicating whether to use the primary inverse transform and/or the secondary inverse transform on any block, slice, picture, or sequence basis from the received bitstream, thereby selectively using the primary inverse transform and/or the secondary inverse transform.

For example, through CBF information on the primary transform coefficient block, which may mean whether to perform the primary inverse transform, the primary inverse transform is not performed when the CBF is 0, and the primary inverse transform is performed when the CBF is 1, thereby performing decoding.

For example, through CBF information about a secondary transform coefficient block that may mean whether to perform secondary inverse transform, the secondary inverse transform is not performed when the CBF is 0, and the secondary inverse transform is performed when the CBF is 1, thereby performing decoding.

For example, by decoding a flag indicating whether to perform primary inverse transform on a picture basis, when the flag is 0, the primary inverse transform my not be performed on all blocks included in the current picture.

For example, by decoding a flag indicating whether to perform secondary inverse transform on a per picture basis is decoded, when the flag is 0, the secondary inverse transform may not be performed on all blocks included in the current picture.

For example, by decoding a flag indicating whether to perform primary inverse transform on a per sequence basis, when the flag is 0, the primary inverse transform may not be performed on all blocks included in the current sequence.

For example, by decoding a flag indicating whether to perform secondary inverse transform on a per sequence basis, when the flag is 0, the secondary inverse transform may not be performed on all blocks included in the current sequence.

The decoder may selectively use the primary inverse transform or the secondary inverse transform according to the component type (luminance or color difference), block size, or prediction mode of the current block.

For example, when the encoder/decoder is defined so that both the primary inverse transform and the secondary inverse transform are always used when using inter prediction, information indicating whether the primary inverse transform is used or whether the secondary inverse transform is implicitly determined, thereby decoding the current block.

For example, when the encoder/decoder is defined so that both the primary inverse transform and the secondary inverse transform are always used when using intra prediction, information indicating whether the primary inverse transform is used or whether the secondary inverse transform is implicitly determined, thereby decoding the current block.

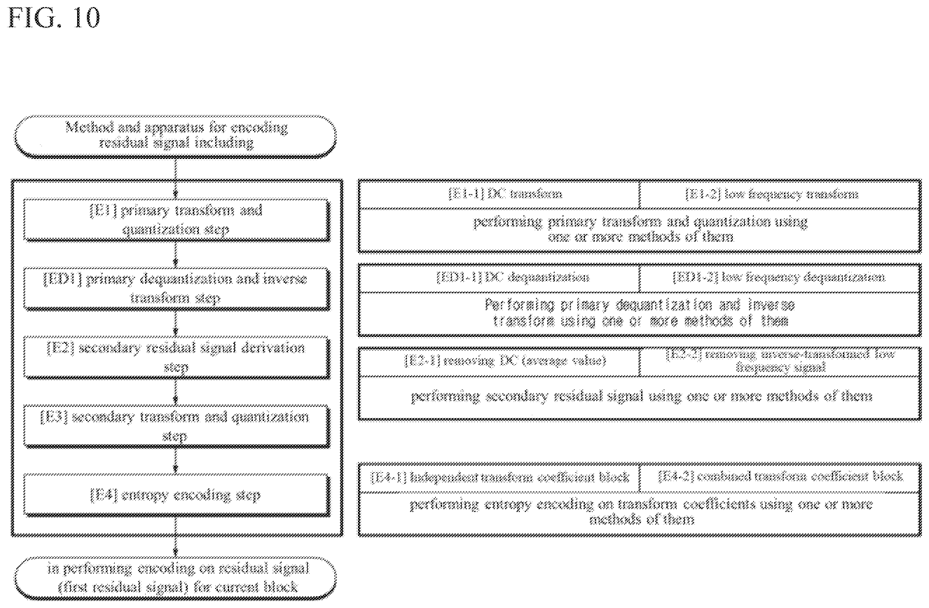

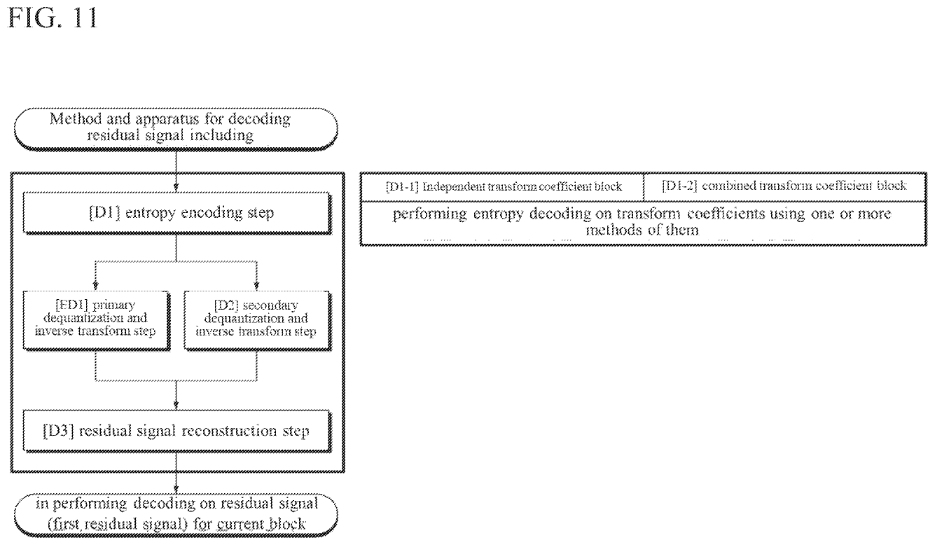

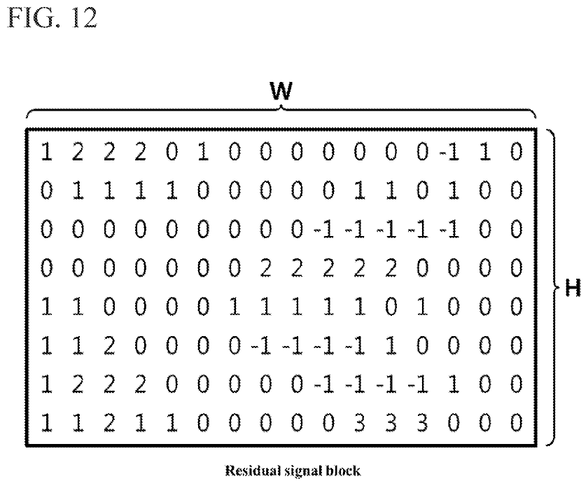

FIG. 10 is a diagram illustrating an embodiment of residual signal encoding according to the present invention.

Referring to FIG. 10, the image encoding apparatus may perform residual signal encoding by performing step [E1] to step [E4].

In FIG. 10, the step [E1] may use at least one method of [E1-1] and [E1-2].

A step [ED1] may use at least one method of [ED1-1] and [ED1-2].

A step [E2] may use at least one method of [E2-1] and [E2-2].

A step [E4] may use at least one method of [E4-1] and [E4-2].

FIG. 11 is a diagram illustrating an embodiment of residual signal decoding according to the present 5 invention.

Referring to FIG. 11, the image decoding apparatus may perform residual signal decoding by performing step [D1] to step [D3].

In FIG. 11, the step [D1] may use at least one method of [D1-1] and [D1-2]. In addition, the step [ED1] may be the same as the step [ED1] of FIG. 10.

Hereinafter, residual signal encoding and residual signal decoding will be described with reference to FIGS. 10 and 11.

[E1] Primary Transform and Quantization Step

By using DC transform or low frequency transform on a primary residual signal block that is a difference between an original signal and a signal of intra prediction or inter prediction for the current block, it is possible to obtain a low frequency of the primary residual signal. In addition, by performing quantization on the corresponding low frequency, the size of information may be reduced even if distortion of the signal occurs.

In the pure sent invention, since the transform and quantization step is added once more, the error of the residual signal may be larger compared to when performing transform and quantization one time. Therefore, in order to reduce quantization error for DC or N low frequencies (where, N is a positive integer greater than or equal to 1 and may be less than the number of pixels in a block), transform coefficients of DC or N low frequencies may be encoded by using quantization parameter QPb that is comparatively less than the quantization parameter QPa used for existing residual signals or by omitting transform and quantization. Here, the difference between QPa and QPb (QPa−QPb) may be transmitted through a parameter set or a header (SPS, PPS, etc.), and the decoder uses the difference and the quantization parameter QPa of the current block to derive the quantization parameter QPb used in primary transform and quantization.

[E1-1] DC Transform

The DC transform may be expressed as a process of obtaining an average value of the residual signal, and a value obtained by performing scaling-up; on the average value (DC value) in the transform process to increase the precision of the transform process may be defined as an input value of the quantization process.

Alternatively, the DC transform is performed using DCT-2 transform in the horizontal and vertical directions for the existing residual signal as it is and may be defined as a process of extracting a result value of the lowest frequency.

The DC quantization is performed using a quantization method of the existing residual signal as it is for the average value of the residual signal or the scaled-up average value, to derive a quantized DC transform for the average value or the scaled-up average value.

[E1-2] Low Frequency Transform

Low frequency transform may be defined as a process of extracting N low frequencies including the lowest frequency after performing transform on a residual signal. Here, the transform may mean a transform such as a rotation transform as well as a DCT or DST transform. Where, N may also be a positive integer.

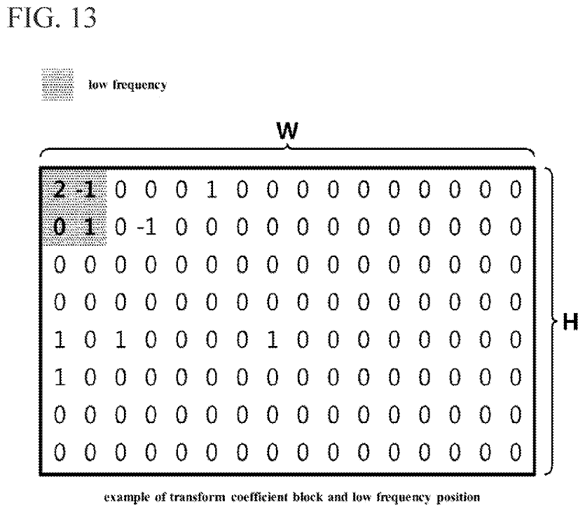

For example, after transforming a block having a W×H size as shown in FIG. 12, four coefficients located at the upper left may be defined as the lowest frequency as shown in FIG. 13. Herein, in order to obtain transform coefficients for N frequencies, the encoder performs only a transform on a corresponding frequency or performs a transform process on horizontal and vertical directions having the same size as a block, thereby extracting only N low frequency transform coefficients. Herein, the transform may be performed on K residual signals or transform coefficients instead of a block having a W×H size. Here, K may be a positive integer and may be a number less than W*H. That is, the transform may be performed on K residual signals or transform coefficients having the number smaller than the size W×H of the block, and N transform coefficients may be extracted. In this case, N may be smaller than K.

The transform kernel used for the low frequency transform may use a transform kernel that may most efficiently represent low frequency components that are statistically most frequently generated in the residual signal. Here, the most efficient transform kernel may be a transform kernel capable of representing a residual signal with only a relatively small number of frequencies.

The encoder may selectively use a transform kernel used for low frequency transform on a per block basis, on a per picture basis, or on a per sequence basis. Here, the block may mean at least one of a coding block, a prediction block, and a transform block. Herein, information on a type of the selected transform kernel may be signaled from the encoder to the decoder.

Quantization for N low frequencies may be performed using a quantization method for an existing residual signal {quantization method for a secondary residual signal} as it is, and quantization is performed only on N transform coefficients so that N quantized coefficients may be derived. Herein, N may be set to the same value in the encoder/decoder, and be used as a fixed value according to the size of the residual block or transmitted through a parameter set or header (SPS, PPS, etc.). The quantized coefficient value may be set to 0 for the remaining transform coefficients not included in the N transform coefficients. That is, at least one of quantization and dequantization may be performed on only the N transform coefficients, and the remaining transform coefficients not included in N transform coefficients may be determined to be zero without performing at least one of quantization and dequantization.

A transform kernel used for a primary transform or a secondary transform may be selectively used according to prediction mode information (intra prediction or inter prediction) or block size information of the current block.

For example, by using at least one of DST-7, DCT-4, DST-4, and DCT-8 for intra prediction, and DCT-2 for inter prediction, low frequency transform may be performed on the primary residual signal.

For example, by using at least one of DCT-2, DST-7 and DCT-8 for intra prediction and at least one of DST-7 and DCT-8 for inter prediction, low frequency transform may be performed on the primary residual signal.

Since the residual signal generated after intra prediction has a characteristic that the longer the distance from a reference sample, the more an error amount, when at least one low frequency basis vector among DST-7, DCT-4, DST-4, and DCT-8 is used, it is possible to perform frequency transform more efficiently than DCT-2.

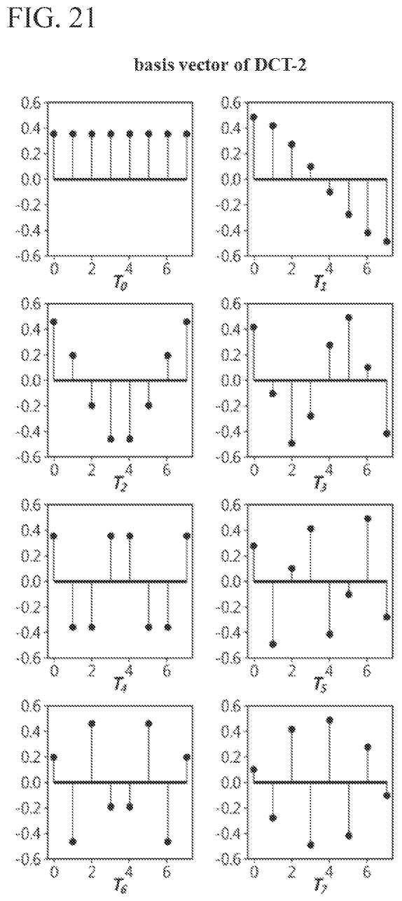

Meanwhile, since residual signals in a block may have a luminance difference of constant size due to changes in the brightness of the object caused by light changes and movements between the reference picture and the current picture in inter prediction, it is possible to perform low frequency transform more efficiently when using the low frequency basis vector of DCT-2 compared to that of DCT-8 or DST-7. In this case, each transform equation may be represented by Equations 1 to 3, and an example of the basis vector is shown in FIGS. 21 to 23.

For example, since selecting a large block in the encoder generally means that the prediction is performed well, transform such as DCT-2 may be efficient. Therefore, when the block size is greater than the arbitrary size, the encoder may efficiently perform the low frequency transform by performing the primary transform using the DCT-2.

Alternatively, when the block size is more than a certain size, the encoder may perform a secondary transform on the existing residual signal, omitting the primary transform. The arbitrary block size information for this purpose may be used with a size predefined by the encoder/decoder or transmitted as block size information through parameter sets or headers (SPS, PPS, etc.).

Herein, when transforming a block having a size of W×H, the primary transform may be performed only when at least one of lengths in the horizontal (W) direction and the vertical (H) direction is less than an arbitrary size, and otherwise, the primary transform may be omitted. The arbitrary size information for this purpose may be used with a size predefined by the encoder/decoder or the size information may be transmitted through parameter sets or headers (SPS, PPS, etc.).

In addition, the secondary transform may be performed only when at least one of lengths in the horizontal (W) and the vertical (H) direction is less than any size, and otherwise, the secondary transform may be omitted. The arbitrary size information for this purpose may be used with a size predefined by the encoder/decoder or the size information may be transmitted through parameter sets or headers (SPS, PPS, etc.).

W and H may be a positive integer, and may be 128.

[ED1] Primary Dequantization and Inverse Transform Step

The encoder may perform an inverse transform on the primary transform coefficients that are a result of the primary transform, to obtain a reconstructed primary residual signal.

When the primary transform process is omitted for the purpose of lossless encoding, the primary inverse transform step may also be omitted.

When the DC transform coefficient is 0 or when the coefficients are all zero, the primary inverse transform step may be omitted.

Meanwhile, the decoder may perform entropy decoding on a CBF syntax element indicating whether a non-zero coefficient exists in a primary low frequency transform coefficient block from a bitstream, thereby omitting a low frequency inverse transform step when the CBF is zero.

[ED1-1] DC Dequantization and Inverse Transform

When the DC transform is performed in the step [E1], the DC inverse transform may be performed.

Dequantization may derive the dequantized. DC coefficient using the same quantization parameter (QP) used in the step [E1].

In addition, in consideration of a degree of scaling-up during the [E1] DC transform process, the dequantized DC transform coefficient is scaled down to the same degree during inverse transform so that a final reconstructed DC value is derived and samples in the primary residual signal block having the same size are filled with the reconstructed DC values, thereby deriving the reconstructed primary residual signal block.

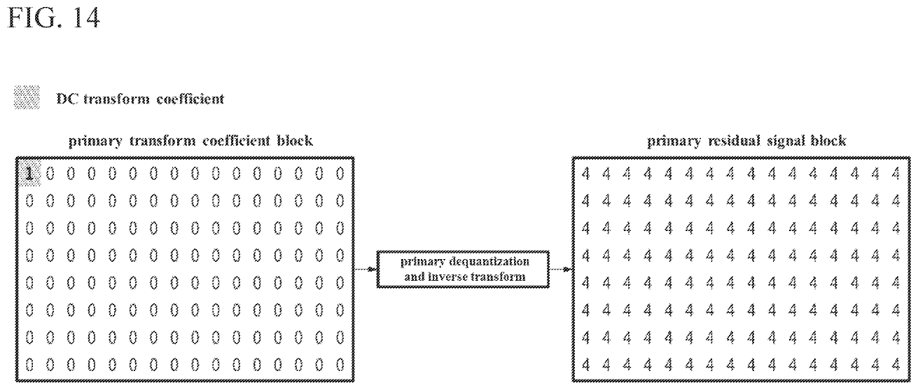

As shown in FIG. 14, before performing an inverse transform, a quantized DC coefficient is included in a lowest frequency and a coefficient for the remaining frequencies is set to 0 to generate a transform coefficient block, and then an inverse transform is performed thereon, thereby deriving a reconstructed primary residual signal block.

[ED1-2] Low Frequency Dequantization and Inverse Transform

When the low frequency transform is performed in the step [E1], the inverse transform may be performed on the low frequency. Herein, dequantization may be performed on N low frequencies using the same quantization parameter used in the [E1] step.

The reconstructed primary residual signal block may be derived by performing an inverse transform using an inverse transform kernel corresponding to the transform kernel used in the step [E1].

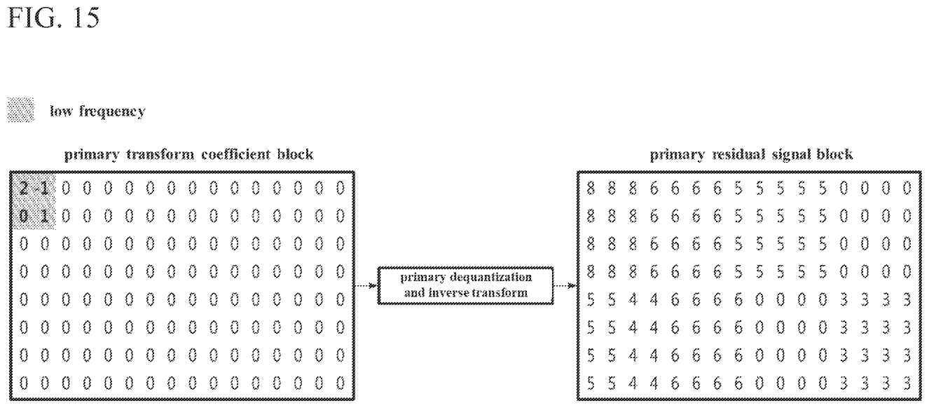

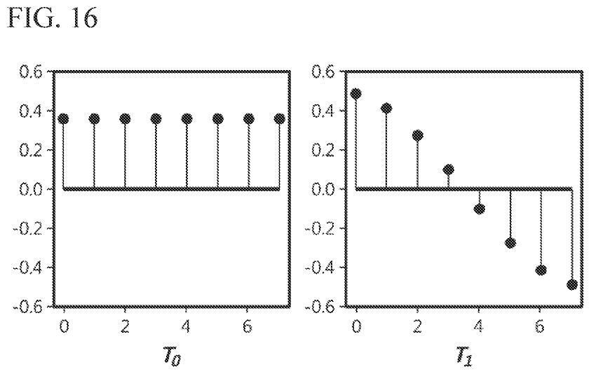

As shown in FIG. 15, before performing an inverse transform, it is possible to generate transform coefficient blocks by allowing four low frequency transform coefficients to be the same shape as the current block size.

As shown in the example of FIG. 15, four quantized low frequency transform coefficients are located in the same region of the transform, coefficient block and the remaining coefficients are set to 0 so that transform coefficient blocks are generated and then inverse transform is performed on the blocks, thereby deriving the reconstructed primary residual signal block.

[E2] Secondary Residual Signal Derivation Step

The secondary residual signal may be derived by subtracting the DC (average value) or the reconstructed low frequency signal from the primary residual signal. When the DC value is zero or the low frequency/signals are all zero, the secondary residual signal may be derived as the same value as the primary residual signal.

[E2-1] Removing DC Value (Average Value)

When the DC inverse transform is performed in the [ED1] step, the secondary residual signal may be derived by subtracting the reconstructed DC value from all samples in the primary residual signal block. Alternatively, the secondary residual signal may be derived by subtracting the DC value (average value) of the primary residual signal instead of the reconstructed DC value from each sample in the primary residual signal.

[E2-2] Removing Inverse-Transformed Low Frequency Signal

When the low frequency inverse transform is performed in the [ED1] step, the secondary residual signal may be derived by subtracting the reconstructed primary residual signal block from the primary residual signal block. Herein, the encoder may subtract the reconstructed primary residual signal block from the primary residual signal block pixel without loss by omitting quantization, thereby deriving a secondary residual signal.

[E3] Secondary Transform and Quantization Step

The encoder may induce a secondary transform coefficient block by performing a transform on the secondary residual signal block.

A transform may be performed on the secondary residual signal using transform kernels using base vectors other than the transform kernel used in the primary transform and quantization step.

For example, when the transform kernel used in the primary transform is DCT-2, the secondary transform may use a DCT-2, DCT-8, DCT-4, DST-4, or DST-7 transform kernel. Alternatively, when the transform kernel used in the primary transform is DST-7 or DCT-8, the secondary transform may use a DCT-2, DCT-4, DST-4, DST-7, or DCT-8 transform kernel.

A transform kernel used for secondary transform may be selectively used according to prediction mode information (intra prediction or inter prediction) of the current block or block size information of the current block.

Upon using the low frequency basis vector of DST-7 or DCT-8 due to the characteristics of the residual signal after the intra prediction, it is possible to obtain efficient transform results. However, since the high frequency component does not have such characteristics, transforms such as DCT-2, DCT-4 or DST-4, other than DST-7 or DCT-8 may be efficient for the secondary transform.

Upon using the low frequency basis vector of the DCT-2 due to the characteristics of the residual signal after the inter prediction, it is possible to efficiently perform the transform of the low frequency. However, since the high frequency component is texture difference information due to the movement and rotation of the object, transforms such as DST-7, DCT-4, DST-4, or 8-DCT other than DCT-2 may be effective for the secondary transform.

In the secondary transform, the secondary transform may be performed only on the remaining frequencies except for the frequencies used in the primary transform.

For example, the transform is performed using T₀ to Tₐ basis vectors of DCT-2 (where a is a positive integer greater than 0 and less than 8) for a secondary residual signal block of 8×8 size in the horizontal and vertical directions for the primary transform, and the transform may be performed using basis vectors of Tₐ₊₁ to T₇ frequencies of DCT-8, DCT-4, DST-4, or DST-7 for the secondary transform.

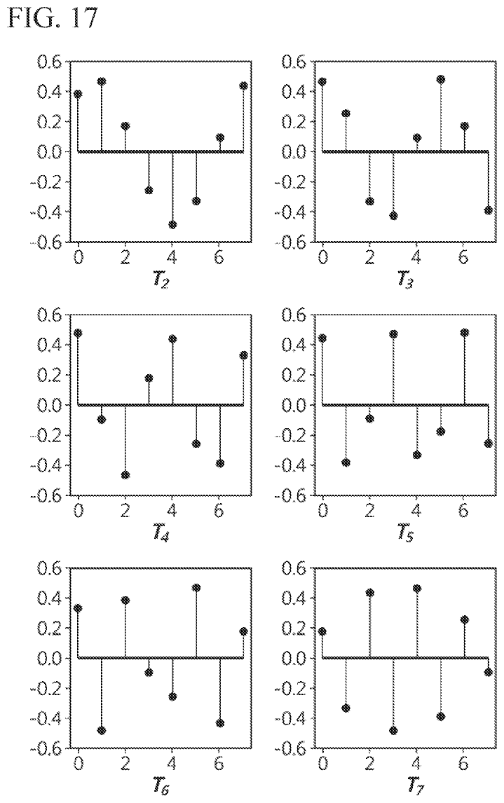

FIGS. 16 and 17 are diagrams showing examples of basis vectors used for the primary transform and the secondary transform.

FIG. 16 shows basis vector used for each frequency when using T₀ and T₁ basis vectors of DCT-2 during the primary transform.

FIG. 17 shows basis vectors used for each frequency when using T₂ to T₇ basis vectors of DST-7 during the secondary transform.

During secondary transform, the encoder may perform frequency transform using a transform kernel that may be represented by minimized rate-distortion cost or the least number of frequencies, when using one or more transform kernels as candidates. Herein, information on the used transform kernel may be signaled from the encoder to the decoder.

During transform, different transform kernels may be used for the horizontal and vertical directions, and a transform kernel capable of being represented by minimized rate-distortion cost or the least number of frequencies may be used as the transform kernel to be used in each direction.

For example, when DCT-2, DCT-S, and DST-7 exist as the transform kernel that may be used in the decoder, by calculating each rate-distortion cost on the secondary residual signal block for three transform kernels, the optimal transform kernel having minimized rate-distortion costs may be selected, and an inverse transform, step and entropy encoding may be performed on the corresponding transform coefficient block.

[E4] Entropy Coding Step;

Primary transform coefficients as a result, of primary residual signal transform and secondary transform coefficients as a result of secondary residual signal transform may be encoded into an independent transform coefficient block or encoded into a form of one transform coefficient block. In addition, entropy encoding may be performed using binarization considering statistical characteristics of coefficients in one or two transform coefficient blocks.

Herein, flag information of a block unit may be entropy encoded and transmitted so that the decoder may recognize whether the primary transform added is used according to the present invention. In addition, when the encoder transmits flag information on whether to use the primary transform in units of any slice, picture, or sequence to the decoder and does not use the primary transform in units of slice, picture, or sequence, it is possible to omit the flag information in units of block.

Herein, the encoder/decoder uses the primary transform only in arbitrary block sizes or arbitrary prediction modes predefined, so that the flag information on a per block basis may be omitted. The encoder may transmit flag information on whether to use the primary transform in units of any slice, picture, or sequence to the decoder.

[E4-1] Independent Transform Coefficient Block

The encoder may perform quantization and entropy encoding on a primary transform coefficient block, that is, primary transformed coefficients, and may independently perform quantization and entropy encoding on a secondary transformed coefficient block.

For example, the encoder may perform DC transform on the primary residual signal, and perform quantization and entropy encoding on up to 1+W×H transform coefficients when the size of the secondary transform coefficient block is W×H. Herein, K may be used instead of 1+W×H. Here, K may be a positive integer and may be a number less than W*H.

For example, the encoder may perform N low frequency transforms on the primary residual signal, and perform quantization and entropy encoding on up to N+W×H transform coefficients when the size of the secondary transform coefficient block is W×H. In this case, K may be used instead of N+W×H. Here, K may be a positive integer and may be a number less than N+W*H.

[E4-2] Combined Transform Coefficient Block

The encoder may combine the primary transform coefficient block and the secondary transform coefficient block to form a transform coefficient block equal to the size of the current block and perform quantization and entropy encoding thereon.

For example, the encoder performs DC transform on the primary residual signal, and when the size of the secondary transform coefficient block is W×H, the lowest frequency may be removed from the secondary transform coefficient block. The encoder may insert a DC transform result into the lowest frequency position (0, 0) to generate a transform coefficient block having a W×H size equal to that of the current block and perform entropy encoding thereon. Herein, K transform coefficients may be used instead of the block of the W×H size. Here, K may be a positive integer and may be a number less than W*H.

Alternatively, the encoder inserts the DC transform result at the lowest frequency position and then rearrange the remaining coefficients except the maximum frequency among the coefficients of the secondary transform coefficient block in a raster order from the position (1,0) to the lower right position of the block, or rearrange the remaining coefficients in the zigzag order or diagonal order from the position (1, 0) or (0, 1), thereby generating the transform coefficient blocks having the same W×H size as the current block size. The encoder may perform quantization and entropy encoding on the generated transform coefficient block. Herein, K transform coefficients may be used instead of the block of the W×H size. Here, K may be a positive integer and may be a number less than W*H.

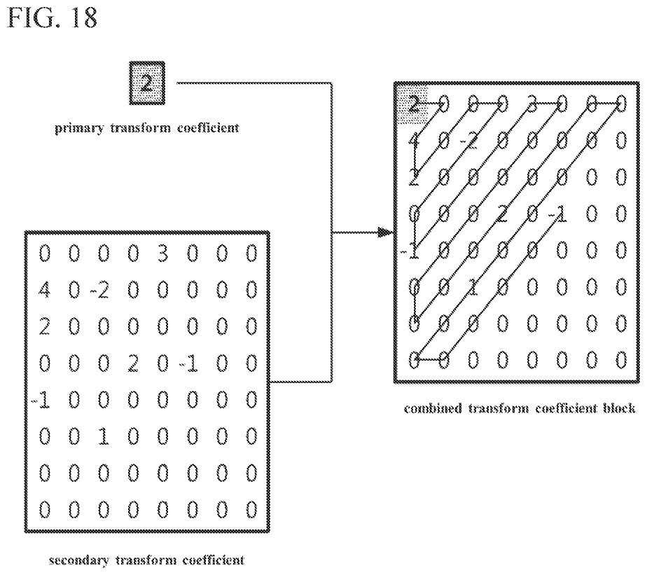

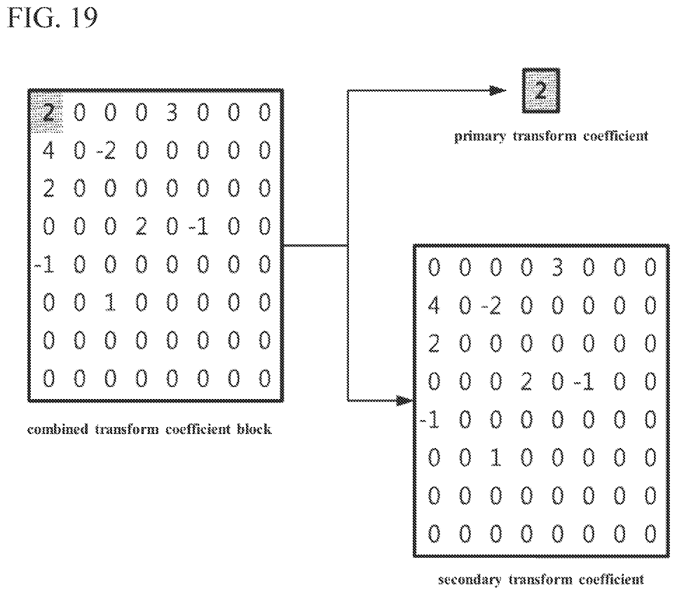

FIG. 18 shows an example of performing entropy encoding in combination of a primary transform coefficient block (DC transform coefficient block) and a secondary transform coefficient block.

As shown in FIG. 18, two transform coefficient blocks may be combined into a transform coefficient block, and entropy encoding may be performed thereon.

For example, the encoder performs N low frequency transforms on the primary residual signal, and when the size of the secondary transform coefficient block is W×H, the encoder removes N low frequency positions in the zigzag order from the top left in the secondary transform coefficient block, and inserts the primary transform coefficients at the low frequency positions removed, thereby generating the transform coefficient block having the W×H size same as the current block size. The encoder may perform quantization and entropy encoding on the generated transform coefficient block. Herein, K transform coefficients may be used instead of the W×H block. Here, K may be a positive integer and may be a number less than W*H.

Alternatively, the encoder removes N low frequency positions in a zigzag order or diagonal order from the upper left to the lower right in the secondary transform coefficient block, inserts the primary transform coefficients into the low frequency positions removed, and then rearranges the remaining transform coefficients except for N high frequencies among the secondary transform coefficients following N primary transform coefficients in a zigzag order or a diagonal order, thereby generating a transform coefficient block having the same W×H size as the current block size. The encoder may perform quantization and entropy encoding on the generated transform coefficient block. Herein, K transform coefficients may be used instead of the block of the W×H block. Here, K may be a positive integer and may be a number less than W*H.

[D1] Entropy Decoding Step

The decoder may perform entropy decoding by using binarization that uses statistical characteristics from the received bitstream. In addition, the decoder may derive up to two independent transform coefficient blocks by performing entropy decoding or derive a primary transform coefficient block and a secondary transform coefficient block from a single combined transform coefficient block.

[D1-1] Independent Transform Coefficient Block

The decoder may perform entropy decoding on the received bitstream to derive N low frequency transform coefficients and a transform coefficient block having the same number of samples as the current block size.

For example, the decoder performs DC inverse transform on the primary residual signal, and when the size of the secondary transform coefficient block is W×H, the decoder performs entropy decoding on 1+W×H transform coefficients to derive one DC transform coefficient and one transform coefficient block of W×H size. Herein, K may be used instead of 1+W×H. Herein, K may be a positive integer and may be a number less than W*H.

For example, the decoder performs N low frequency inverse transforms on the primary residual signal, and when the size of the secondary transform coefficient block is W×H, the decoder performs entropy decoding on N+W×H transform coefficients to derive N primary transform coefficient blocks and secondary transform coefficient blocks of W×H size. Herein, K may be used instead of N+W×H. Here, K may be a positive integer and may be a number less than N+W*H.

[D1-2] Combined Transform Coefficient Block

The decoder may perform entropy decoding on transform coefficients equal to the sample number of the current, block from the received bitstream to derive N low frequency transform coefficients and a transform coefficient block having the same size as that of the current block.

For example, when decoding is performed on a primary residual signal in combination of a DC transform coefficient and a secondary transform coefficient block, the decoder considers a coefficient present at the lowest frequency position (0, 0) as a DC transform coefficient and derives the secondary transform coefficient blocks using the remaining coefficients. Herein, the decoder may derive the secondary transform coefficient block by considering the lowest frequency of the secondary transform coefficient block as 0 or the coefficient for the maximum frequency as 0. In the latter case, the decoder may rearrange the transform coefficients using the coefficient scanning order (zigzag or diagonal) used by the encoder so that the coefficient corresponding to the lowest frequency is located at the upper left.

FIG. 19 is a diagram illustrating an example of decomposing a combined transform coefficient block into a primary transform coefficient block (DC transform coefficient) and a secondary trans form coefficient block.

Decomposition into two transform coefficient blocks is performed in an entropy decoding step as shown in FIG. 19, and a primary inverse transform and a secondary inverse transform may be performed on the two transform coefficient blocks, respectively.

For example, when the primary transform coefficient block and the secondary transform coefficient block are combined with the same size as the current block and then entropy decoded, the decoder derives the primary transform coefficient block by generating a two-dimensional transform coefficient block for N coefficients located at low frequencies in the combined transform coefficient block using a zigzag or diagonal scanning order and by considering coefficients corresponding to the remaining frequencies as 0. In addition, the decoder may derive the secondary transform coefficient block using the remaining coefficients, except for the N low frequency coefficients of the combined transform coefficient block. Herein, the decoder may derive the secondary transform coefficient block by considering the secondary N low frequency coefficients as 0 or the coefficients for the N high frequencies from the maximum frequency as 0. In the latter case, the decoder may rearrange the transform coefficients using the transform coefficient scanning order (zigzag or diagonal) used by the encoder so that the lowest frequency is located at the upper left.

In a method of entropy encoding and decoding a DC transform coefficient, the encoder/decoder predicts the DC transform coefficient of the current block by using an average value or DC transform coefficient of residual signals of blocks that are spatially adjacent to each other, thereby entropy encoding and decoding the difference value between them. Alternatively, the encoder/decoder may entropy encode and decode the DC transform coefficient of the current block without prediction.

For example, the encoder/decoder uses an average value or DC transform of the reconstructed residual signals of at least one or more blocks using DC transform among the encoded/decoded blocks (upper, left, upper left or upper right) adjacent to the current block, to predict DC transform coefficients. The encoder/decoder may entropy encode and decode a difference value between the predicted DC transform coefficient and the DC transform coefficient (average value) of the current block.

Herein, when there are two or more blocks using DC transform among neighboring blocks, the encoder/decoder predicts an average value of DC transform coefficients of the corresponding blocks as a DC transform coefficient or a predicts the DC transform coefficient by using the DC transform coefficient of the block having the closest spatial distance to the current block among neighboring blocks. Alternatively, when the upper or left block mode DC transform is used, the encoder/decoder may predict the DC transform coefficient using a DC transform coefficient at a fixed position (top or left).

Alternatively, the encoder/decoder may predict the DC transform coefficient by using the coefficient value located at the lowest frequency or an average value of reconstructed residual signal of a block using DCT transform kernel or the same block size or the same prediction mode as the current block among the encoded and decoded blocks (upper, left, upper left or upper right) adjacent to the current block. The encoder/decoder may entropy encode and decode a difference value between the predicted DC transform coefficient and the DC transform coefficient (average value) of the current block.

Herein, when there are two or more blocks having the DCT transform kernel or the same block size or the same prediction mode as the current block among the neighboring blocks, the encoder/decoder may derive the predicted DC transform coefficient of the current block by using an average of the reconstructed residual signals of the blocks or an average value of transform coefficients located at the lowest frequency. Alternatively, the encoder/decoder may derive a predicted DC transform coefficient using a DC transform coefficient at a fixed position (upper or left).

When the DC transform coefficient for the primary residual signal is 0, the result of the final reconstructed block is the same as omitting the DC transform. Since it is efficient in terms of entropy to eliminate cases where the same result may be obtained when two methods exist, when the DC transform method is selectively used, the encoder may process so that the DC transform coefficient of the block using DC transform is not zero. Herein, since the DC transform coefficient may always be an integer other than 0, the encoder/decoder may entropy encode and decode a value obtained by subtracting 1 from an absolute value of the DC transform coefficient.

In the method for entropy encoding and decoding a primary transform coefficient block, the encoder/decoder may rearrange the 2D transform coefficient blocks into the 1D transform coefficients using a zigzag scan or a diagonal scan from a maximum frequency to a minimum frequency or a minimum frequency to a maximum frequency, thereby performing entropy encoding and decoding. In this case, the scanning method used may be the same as the scanning method used in the secondary transform coefficient block, or the scanning method predefined by an encoder/decoder may be used.

The encoder/decoder may predict transform coefficients of the primary transform coefficient blocks by using transform coefficients of primary transform coefficient blocks of spatially adjacent blocks, and entropy encode and decode the difference values thereof. Alternatively, the encoder/decoder may entropy encode and decode the primary transform coefficient block of the current block as it is without prediction.

For example, when there are blocks that have the same size as the current block, use a primary transform or use a DCT transform, among the encoded blocks adjacent to the current block (top, left, top left or top right), the encoder/decoder may predict the primary transform coefficients using the transform coefficients of the corresponding blocks. That is, the encoder/decoder may entropy encode and decode a difference value between the coefficients in the predicted primary transform coefficient block located at the same frequency and the coefficients in the primary transform coefficient block of the current block. Herein, when there are two or more block that use the same size as the current block, use the primary transform, or use the DOT transform, the encoder/decoder may predict the transform coefficients of the same frequency of the current block using the average value of the transform coefficients for each frequency of the corresponding blocks. Alternatively, the encoder/decoder may predict transform coefficients of the same frequency of the current block by using coefficients in the transform coefficient block at a fixed position (upper or left).

When the transform coefficients of the primary transform coefficient block are all zero, the encoder/decoder may process so that at least one coefficient having a nonzero value results because the result of the last reconstructed block is the same as omitting the primary transform. Herein, since the coefficient to be transmitted last in the transform coefficient block may always be an integer other than 0, the encoder/decoder may entropy encode and decode a value obtained by subtracting 1 from the absolute value of the transform coefficient. Since the CBF indicating whether the non-zero transform coefficient is present may be always assumed to be 1, the encoder may not transmit the CBF for the primary low frequency transform coefficient block.

When the transform coefficients of the secondary transform coefficient block are all zero, the result of the last reconstructed block is the same as that of omitting the secondary transform. Herein, since only the primary transform is performed, the same result as using only one transform kernel (DCT-2, DCT-8, DCT-4, DST-4, or DST-7) may be obtained. Thus, the encoder may process so that such a case does not occur. That is, since the secondary transform coefficient block may assume that the CBF indicating whether the non-zero transform coefficient is present is airways 1, the encoder may not transmit the CBF for the secondary transform coefficient block. Since the transform coefficient to be transmitted last among the transform coefficients may be always an integer other than 0, the encoder/decoder may entropy encode and decode a value obtained by subtracting 1 from the absolute value of the coefficient.

The encoder/decoder may perform binarization in consideration with statistical characteristics for a DC transform coefficient or coefficient information in primary transform coefficient block, secondary transform coefficient block, or a combined transform coefficient block (a different from the predicted transform coefficient, absolute value of the transform coefficient, or a value obtained by subtracting 1 from the absolute value)

Herein, the binarization may mean a process of transforming the magnitude and code information of the coefficient into a binary bitstream in a encoder or a process of transforming the same into a binary string that is an input of a binary arithmetic encoder. The binarization may mean a binarization method of transforming the bitstream into the size and the sign information of the coefficient in the decoder or a binarization method of transforming the output of the binary arithmetic decoding into the size and the sign information of the coefficient.

For example, the magnitude information of the coefficient may be binarized using a binarization method such as truncated Rice, unary, truncated unary, or the like. Herein, when there are characteristics that a large number of values are statistically generated near the value of zero, each of binary values near the value of zero is averagely expressed in 1 bit or less by using updateable probability (occurrence probability of 0 or 1) information, thereby improving the compression rate.

For example, binarization may be performed using binarization methods such as k-order exponential Golomb, fixed length, and the like.

Alternatively, binarization may be performed by combining at least two binarization methods of the binarization methods.

For example, when the symbol x to be binarized is equal to or less than a cutoff value c predefined by the encoder/decoder, the encoder/decoder performs binarization using the truncated unary binarization method; when it exceeds the value of c, the encoder/decoder performs the truncated unary binarization method on the value of c; in the case erf the remaining x-c values, the encoder/decoder performs binarization using the k-order exponential Golomb binarization method,

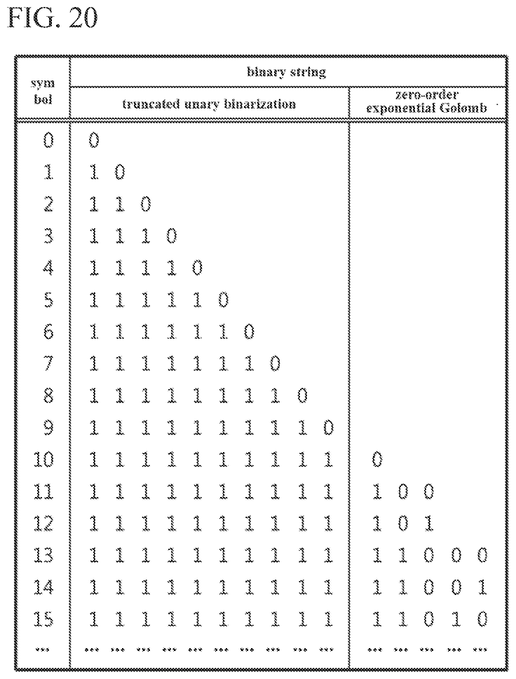

FIG. 20 is a diagram illustrating an example of a binary string that is an output of a binarization process for input symbols 0 to 15 in the case that c is 10 in combination of truncated unary binarization and zero-order exponential Golomb binarization.

Alternatively, when using the k-order exponential Golomb binarization method, it is possible to improve the compression ratio by increasing or decreasing k according to the size of the transform coefficient or symbol previously binarized.

For example, in the case that the size of a symbol or transform coefficient that has been previously binarized according to the scanning order or the encoding and decoding order of the block is greater than or equal to the threshold defined by the encoder/decoder, when the size of the symbol to be currently encoded and decoded is large by increasing the k-order, the encoder/decoder may represent the size of the current symbol with a less number of bits compared to the low-order exponential Golomb binarization method. When the size of the symbol to be currently encoded and decoded is small by maintaining or decreasing the k-order, the encoder/decoder may represent the size of the symbol with a smaller number of bits compared to the higher order exponential Golomb binarization method.

In the combined transform coefficient block, entropy encoding and decoding may be performed on the primary transform coefficients and the secondary transform coefficients by using binarization methods different from each other or using probability information different from each other. In addition, when exponential Golomb binarization is used, exponential-Golomb binarization methods having orders different from each other may be performed on the transform coefficients of the primary transform results and the transform coefficients of the secondary transform results.

[D2] Secondary Dequantization and Inverse Transform Step

The encoder/decoder may perform an inverse transform on the secondary transform coefficient block to derive a reconstructed secondary residual signal block.

The encoder/decoder may perform inverse transform on the secondary transform coefficient block using inverse transform kernels other than the inverse transform kernel used in the primary inverse transform step.

For example, when the kernel used for inverse transform for the primary transform coefficient block or DC transform coefficient is DCT-2, DCT-2, DCT-8, DCT-4, or DST-7 inverse transform kernel may be used for inverse transform on the secondary transform coefficient block. On the contrary, when the kernel used for inverse transform on the primary transform coefficient block or the DC transform coefficient is DST-7 or DCT-8, DCT-2, DCT-4, DST-4, DST-7, or DCT-8 transform kernel may be used for the inverse transform on the secondary transform coefficient block.

The kernel used for inverse transform of the secondary transform coefficient block may be selectively used according to prediction mode information (intra prediction or inter prediction) of the current block or block size information of the current block.

For example, a transform such as DCT-2, DST-7, DCT-4, DST-4, or DCT-8 may be used for inverse transform of the secondary transform coefficient block with respect to the block using the intra prediction mode.

For example, a transform such as DST-7, DCT-4, DST-4, or DCT-8 other than DCT-2 may be used for inverse transform of a secondary transform coefficient block with respect to a block using an inter prediction mode.

During inverse transform for the secondary transform coefficient block, the encoder/decoder may perform secondary inverse transform only on the remaining frequencies except for frequencies undergoing inverse transform in the primary inverse transform.

For example, during the primary inverse transform, the encoder/decoder may perform an inverse transform using basis vectors T₀ to Tₐ of DCT-2 (where a is a positive integer greater than 0 and less than 8) for secondary residual signal blocks of 8×8 size in horizontal and vertical directions. In addition, during the inverse transform on the secondary transform coefficient block, the encoder/decoder may perform an inverse transform using DCT-8, DCT-4, DST-4, or DST-7 on transform coefficients corresponding to frequencies Tₐ₊₁ to T₇ of DCT-8, DCT-4, DST-4, or DST-7.

During inverse transform on the secondary transform coefficient block, the encoder may use the same kernel as that used for transform, and the decoder may perform entropy decoding on an index or flag indicating which transform kernel the current block uses in encoding from the bitstream, so that inverse transform may be performed on the secondary transform coefficient block using the transform kernel corresponding to the index. Herein case, the encoder/decoder may perform inverse transform using different kernels from each other in the horizontal direction and the vertical direction.

When the CBF indicating whether there is a non-zero transform coefficient for the secondary transform coefficient block is 0, the encoder/decoder may omit an inverse transform for the secondary transform coefficient block.

[D3] Residual Signal Reconstruction Step

The encoder/decoder may add a primary reconstructed residual signal block and a secondary reconstructed residual signal block to generate a final reconstructed residual signal block.

The encoder/decoder may clip a value obtained by adding a primary reconstructed residual signal block and a secondary reconstructed residual signal block so that the value is within minimum and maximum ranges of a residual signal value predefined by the encoder/decoder. Alternatively, the encoder/decoder may add all the primary reconstructed residual signal block, the secondary reconstructed residual signal block, and the prediction signal block, and then clip the resulting value so that the value is within the minimum and maximum ranges of the residual signal value predefined by the encoder/decoder.

The transform used herein may be selected from among N predefined transform candidate sets for each block. Here, N may be a positive integer.

Each of the transform candidates may specify a primary horizontal transform, a primary vertical transform, and a secondary transform, (which may be the same as the identity transform).

The list of transform candidates may vary depending on block size and prediction mode. The selected transform may be signaled as follows.

When the coding block flag is 1, a flag indicating whether a first transform of the candidate list is used may be transmitted.

When the flag specifying whether the first transform of the candidate list is used is 0, the following may be applied.

When the number of non-zero transform coefficient levels is greater than the threshold value, a transform index indicating a used transform candidate may be transmitted. Otherwise, a second transform of the list may be used.

When the size of the transform is greater than or equal to M×N, all of the transform coefficients present in regions of M/2 to M and N/2 to N may be set to a value of 0 when performing the transform or after performing the transform. Fie re, M and N are positive integers, for example, may be 64×64.

In order to reduce the memory requirement, a right shift operation may be performed by K on the transform coefficient generated after performing the transform.

In addition, a right, shift operation may be performed by K on the temporary transform coefficient generated after performing the horizontal transform.

In addition, a right shift operation may be performed by K on the temporary transform coefficient generated after performing the vertical transform. Here, K is a positive integer.

In order to reduce the memory requirement, the right shift operation may be performed by K on the reconstructed residual signal generated after performing the inverse transform.

In addition, the right shift operation may be performed by K on the temporary transform coefficient generated after performing the horizontal inverse transform.

In addition, the right shift operation may be performed by K on the temporary transform coefficient generated after the longitudinal inverse transform is performed. Here, K is a positive integer.

In addition, at least one of transforms, such as DCT-4, DCT-8, DCT-2, DST-4, DST-7 used in the present specification may be replaced with at least one of transforms calculated based on transforms such as DCT-4, DCT-8, DCT-2, DST-4, and DST-7. Here, the calculated transform may be a transform calculated by changing coefficient values in transform matrixes such as DCT-4, DCT-8, DCT-2, DST-4, and DST-7.

In addition, the coefficient values in the transform matrixes such as DCT-4, DCT-8, DCT-2, DST-4, DST-7 may have integer values. That is, the transforms of DCT-4, DCT-8, DCT-2, DST-4, and DST-7 may be integer transforms.

In addition, the coefficient value in the calculated transform matrix may have an integer value. That is, the calculated transform may be an integer transform.

In addition, the calculated transform is obtained by performing a left shift operation by N on coefficient values in a transform matrix such as DCT-4, DCT-8, DCT-2, DST-4, DST-7, and the like. Where, N may be a positive integer.

The DCT-Q and DST-W transforms may include the DCT-Q and DST-W transforms, and the DCT-Q and DST-W inverse transforms. Here, Q and W may have a positive value of 1 or more, for example 1 to 9 may be used as the same meanings as I to IX.

In addition, transforms used in the present specification, such as DCT-4, DCT-8, DCT-2, DST-4, DST-7, is not limited to the corresponding transform, and at least one of DCT-Q and DST-W transforms may be used in place of the DCT-4, DCT-8, DCT-2, DST-4, and DST-7 transforms. Here, Q and W may have a positive value of 1 or more, for example 1 to 9 may be used as the same meanings as I to IX.

In addition, the transform as used herein may mean at least one of a transform and an inverse transform.

The DCT-2 transform kernel may be defined by Equation 1 below. Here, Tᵢ may represent a basis vector according to a position in the frequency domain, and N may represent the size of the frequency domain.

$${T}_{i} ( j ) = {w}_{0} \cdot \sqrt{\frac{2}{N}} \cdot cos ( \frac{π \cdot i \cdot ( 2 j + 1 )}{2 N} ) i , j = 0 , 1 , … , N - 1 \\ where , {w}_{0} = \{ \begin{matrix}\frac{1}{\sqrt{2}} & i = 0 \\ 1 & i \neq 0\end{matrix} \qquad [ Equation 1 ]$$

Meanwhile, FIG. 21 shows an example of a basis vector in the DCT-2 frequency domain according to the present invention. Here, a value calculated through a basis vector T₈ of DCT-2 may mean a DC component.

The DCT-8 transform kernel may be defined as Equation 2 below. Here, Tᵢ may represent a basis vector according to a position in the frequency domain, and N may represent the size of the frequency domain.

$${T}_{i} ( j ) = \sqrt{\frac{4}{2 N + 1}} \cdot cos ( \frac{π \cdot ( 2 i + 1 ) \cdot ( 2 j + 1 )}{4 N + 2} ) i , j = 0 , 1 , … , N - 1 \qquad [ Equation 2 ]$$

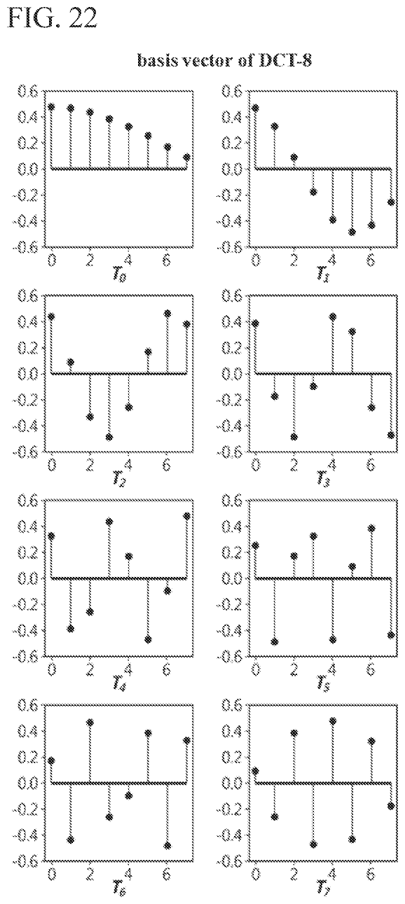

Meanwhile, FIG. 22 shows am example of a basis vector in the DCT-8 frequency domain according to the present invention.

The DST-7 transform kernel may be defined as Equation 3 below. Here, T₇ may represent a basis vector according to a position in the frequency domain, and N may represent the size of the frequency domain.

$${T}_{i} ( j ) = \sqrt{\frac{4}{2 N + 1}} \cdot sin ( \frac{π \cdot ( 2 i + 1 ) \cdot ( j + 1 )}{2 N + 1} ) i , j = 0 , 1 , … , N - 1 \qquad [ Equation 3 ]$$

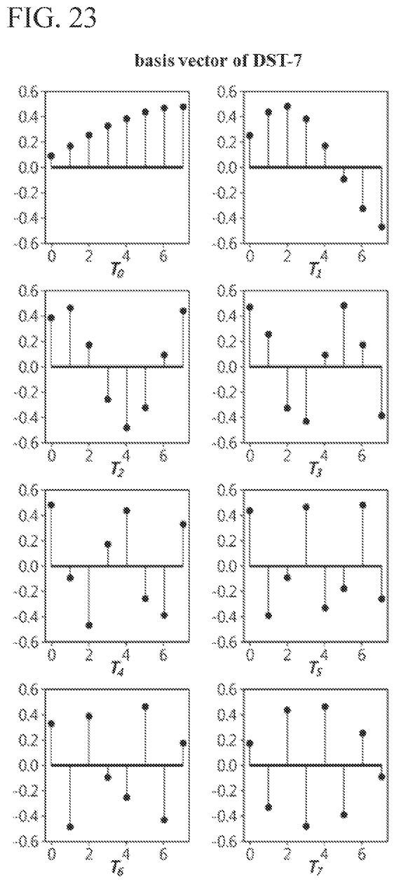

Meanwhile, FIG. 23 shows an example of a basis vector in the DST-7 frequency domain according to the present invention. It may be seen from the basis vector chart the low frequency of the DST-7 is efficient when the magnitude of the signal input later in time is relatively larger than the magnitude of the signal input earlier.

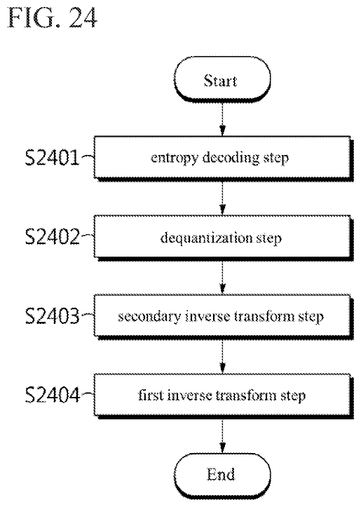

FIG. 24 is a flowchart illustrating an image decoding method according to an embodiment of the present invention.

Referring to FIG. 24, the image decoding method may include an entropy decoding step S2401, a dequantization step S2402, a secondary inverse transform step S2403, and a primary inverse transform step S2404.

The entropy decoding step S2401 may perform entropy decoding on the received bitstream to generate a quantized level.

The dequantization step S2402 may perform dequantization on the quantized level to generate a secondary transform coefficient.

The secondary inverse transform step S2403 may applying the secondary inverse transform to the transform coefficient generated in the dequantization step to generate a primary transform coefficient. The secondary inverse transform may be performed using a low frequency inverse transform.

The transform method used for the low frequency inverse transform may be selectively applied among a plurality of transform methods, and the decoder may signal the transform method selection information in units of block, picture, or sequence. Alternatively, the transform method used for the low frequency inverse transform may be determined according to the intra prediction mode. Here, the transform method may mean a transform kernel or a transform matrix.

As an example, the transform method used for the low frequency inverse transform may be determined on the basis of at least one of a range of the intra prediction mode and transform method selection information obtained from the bitstream.

In addition, when the division of the luminance component and the chrominance component does not follow the same tree structure, the transform method selection information may be signaled for the luminance component and the chrominance component, respectively.

Meanwhile, whether to apply the secondary inverse transform may be determined on the basis of at least one of prediction mode information and block size information.

For example, in inverse transform for a block of size W×H, the secondary inverse transform step may be performed only when at least one or more of the lengths in the horizontal (W) and vertical (H) direction is less than any size, and otherwise, the secondary inverse transform step may be omitted. As the arbitrary size information for this purpose, the sizes predefined by the encoder/decoder may be used, and the size information may be transmitted through parameter sets or headers (SPS, PPS, etc.).

As an example, the secondary inverse transform may be performed only in the case of the intra prediction mode.

Meanwhile, the range to which the secondary inverse transform is applied may be determined on the basis of the size of the current block.

For example, when a smaller value of the width or height of the current block is smaller than the predefined value p, the secondary inverse: transform may be performed only in the N×N region. When the smaller value of the width or height of the current block is larger than the predefined value q, the secondary inverse transform may be performed only in the M×M region. Here, p may be defined as 8, q may be 4, N may be 4, and M may be 8. Here, K secondary transform coefficients may be used instead of the N×N region. Here, K may be a positive integer, and K may be smaller than N*N. In addition, L secondary transform coefficients may be used instead of the M×M region. Herein, L may be a positive integer, and L may be smaller than M*M.

For example, a secondary inverse transform may be performed on transform coefficients for N frequencies to generate a primary transform coefficient block having a W×H size. Here, K primary transform coefficients may be generated instead of the primary transform coefficient block having a W×H size. Here, K may be a positive integer and may be a number less than W*H. That is, secondary inverse transform may be performed on N secondary transform coefficients, and K primary transform coefficients smaller than the size W×H of a block may be extracted. Here, N may be smaller than K.

Meanwhile, the secondary inverse transform step may be performed after the 2D transform coefficient block is arranged into 1D transform coefficients using at least one of a zigzag scan, a vertical scan, a horizontal scan, or a diagonal scan. The 1D transform coefficients resulting from performing the secondary inverse transform step may be rearranged into 2D transform coefficient blocks using at least one of zigzag scan, vertical scan, horizontal scan, or diagonal scan.

As an example, the secondary inverse transform may be performed after the 4×4 transform coefficient block is rearranged into 16×1 transform coefficients using a diagonal scanning method. After the secondary inverse transform is performed, the transform coefficients are arranged into the 4×4 transform coefficient block using at least one of a zigzag scan, a vertical scan, a horizontal scan, or a diagonal scan.

Meanwhile, the secondary inverse transform step may be performed using at least one method of the above-described [E1-1] DC transform, [E1-2] low frequency transform, [ED1-1] DC inverse transform, and [ED1-2] low frequency inverse transform.

The primary inverse transform step S2404 may apply the primary inverse transform to the primary transform coefficient generated in the secondary inverse transform step to generate a residual block. The primary inverse transform may be performed using at least one of a plurality of predefined transform methods. For example, the predefined plurality of transform methods may include DCT-2, DST-7, and DCT-8.

Meanwhile, the primary inverse transform step may be performed using the [E3] secondary transform method and [D2] secondary inverse transform method that are described above.

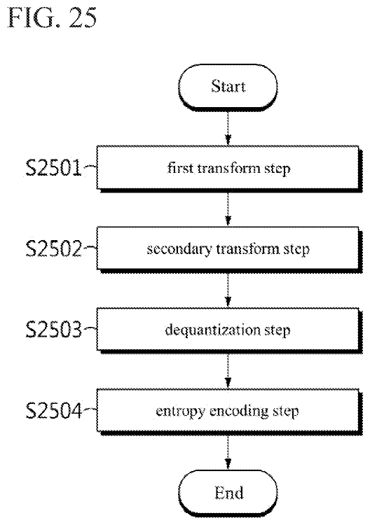

FIG. 25 is a flowchart illustrating an image encoding method according to an embodiment of the present invention.

Referring to FIG. 25, the image encoding method may include a primary transform step; S2501, a secondary transform step 32502, a quantization step; S2503, and an entropy encoding step 32504.

The primary transform step S2501 may be performed using at least one of a plurality of predefined transform methods. For example, the predefined plurality of transform methods may include DCT-2, DST-7, and DCT-8. In the primary transform step, a primary transform coefficient may be generated by applying at least one of a plurality of transform methods predefined to a residual block. Here, the transform method may mean a transform kernel or a transform matrix.

Meanwhile, the primary transform step may be performed using the [E3] secondary transform method and [D2] secondary inverse transform method that are described above.

The secondary transform step S2502 may apply the secondary transform to the primary transform coefficient generated in the primary transform step to generate a secondary transform coefficient.

The secondary transform may be performed using a low frequency transform. In detail, the low frequency transform may be defined as a process of extracting N low frequency transform coefficients including the lowest frequencies from the residual blocks to which the primary transform is applied.

For example, after performing the primary transform on the residual block or transform coefficient block having a W×H size as shown in FIG. 12, four coefficients located at the upper left as shown in FIG. 13 may be defined as the lowest frequency. Herein, the encoder performs only a transform for a corresponding frequency to obtain transform coefficients for N frequencies, or performs transform processes for horizontal and vertical directions having the same size as a residual signal block or transform coefficient block, to extract only N low frequency transform coefficients. Herein, transform may be performed on K residual signals or transform coefficients instead of the residual block or transform coefficient block having a W×H size. Here, K may be a positive integer and may be a number less than W*H. That is, secondary transforms may be performed on the primary transform coefficients or K residual signals having the number smaller than that of the size W×H of the block, and N secondary transform coefficients may be extracted. Herein, N may be smaller than K.

The transform method used for the low frequency transform may be selectively applied among a plurality of transform methods, and the encoder may signal the transform method selection information in block units or in picture or sequence units. Alternatively, the transform method used for the low frequency transform may be determined according to the intra prediction mode. Here, the transform method may mean a transform kernel or a transform matrix.

As an example, the transform method used for the low frequency transform may be determined on the basis of at least one of the range of the intra prediction mode and the transform method selection information.

In addition, when the partition of the luminance component and the chrominance component is not according to the same tree structure, the transform method selection information may be signaled for the luminance component and the chrominance component, respectively.

Meanwhile, whether to apply the secondary transform may be determined on the basis of at least one of prediction mode information and block size information.

For example, when transforming a block having a size of W×H, the secondary transform step may be performed only when at least one of the lengths in the horizontal (W) and vertical (H) directions is less than a predetermined size, and otherwise, the secondary transform step may be omitted. As the arbitrary size information for this purpose, the size predefined by the encoder/decoder is used, or size information may be transmitted through parameter sets or headers (SPS, PPS, etc.).

As an example, the secondary transform may be performed only in the intra prediction mode.

Meanwhile, the range to which the secondary transform is applied may be determined on the basis of the size of the current block.

For example, when a smaller value of the width or height of the current block is smaller than the predefined value p, the secondary transform may be performed only on the N×N region. When the smaller value of the width or height of the current block is greater than the predefined value q, the secondary transform may be performed only in the M×M region. Here, p may be defined as 8, q may be 4, N may be 4, and M may be 8, respectively. Here, K primary transform coefficients may be used instead of the N×N region. Herein, K may be a positive integer, and K may be smaller than N*N. In addition, L primary transform coefficients may be used instead of the M×M region. In this case, L may be a positive integer, and L may be smaller than M*M.

Meanwhile, the secondary transform step may be performed after rearranging the 2D transform coefficient block into 1D transform coefficients using at least one of zigzag scan, vertical scan, horizontal scan, or diagonal scan. The 1D transform coefficients on which the secondary transform step is performed may be rearranged into 2D transform coefficient blocks using at least one of zigzag scan, vertical scan, horizontal scan, or diagonal scan.

As an example, the secondary transform may be performed after rearranging the 4×4 transform, coefficient block into 16×1 transform coefficients using a diagonal scanning method. After the secondary transform is performed, the transform coefficients may be rearranged into the 4*4 transform coefficient block using at least one of zigzag scan, vertical scan, a horizontal scan, or diagonal scan.

Meanwhile, the secondary transform step may be performed by using at least one method of the [E1-1] DC transform, [E1-2] low frequency transform, [ED1-1] DC inverse transform, and [ED1-2] low frequency inverse transform described above.

The quantization step S2503 may perform quantization on a result obtained by performing at least one of the primary transform step and the secondary transform step, to generate a quantized level.

The entropy coding step (S2504) may perform entropy encoding on the quantized level and include the same in the bitstream.

Meanwhile, an entropy decoding step S2401, a dequantization step S2402, a secondary inverse transform step S2403, and a primary inverse transform step S2404 of FIG. 24 may be inverse processes corresponding to the entropy coding step S2504, and secondary transform step S2503, the primary transform step S2502, and the quantization step S2501 of FIG. 25, respectively.

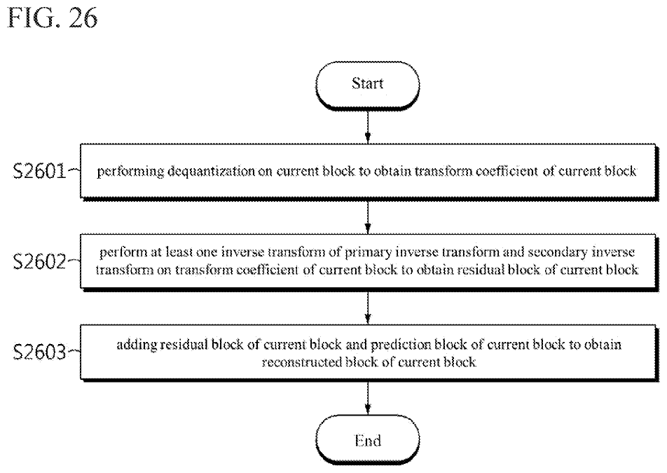

FIG. 26 is a flowchart illustrating an image decoding method according to an embodiment of the present invention.

Referring to FIG. 26, the image decoding apparatus may perform dequantization on the current block to obtain a transform coefficient of the current block (S2601).

In addition, the image decoding apparatus may perform at least erne inverse transform of a primary inverse transform and a secondary inverse transform on the transform coefficient of the current block to obtain a residual block of the current block (S2602).

Here, the secondary inverse transform may be performed only when the current block is the intra prediction mode. In addition, whether to perform the secondary inverse transform may be determined on the basis of the size of the current block.

The secondary inverse transform according to the present invention may be performed between dequantization and primary inverse transform.

The secondary inverse transform according to the present invention may be performed using a low frequency inverse transform. Since the low frequency inverse transform has been described above, a detailed description thereof will be omitted.

The secondary inverse transform according to the present invention may use a transform method determined according to the intra prediction mode of the current block. Alternatively, the transform method determined according to the transform method selection information obtained in the bitstream may be used.

The secondary inverse transform according to the present invention may be performed after rearranging the transform coefficient of the current block from a 2D block format into a 1D list format. Here, the 2D block format may mean a two-dimensional block, and may include, for example, a 4×4 block. In addition, the 1D list format may mean a one-dimensional list, and may include, for example, a set of {X0, X1, ˜, Xn}.

The secondary inverse transform according to the present invention may be performed in an application range determined on the basis of a smaller value of the width or height of the current block.

In addition, the image decoding apparatus may add the residual block of the current block and the prediction block of the current block to obtain a reconstructed block of the current block (S2603).

The image decoding method has been described above with reference to FIG. 26. The image encoding method of the present invention may also be described similarly to the image decoding method described with reference to FIG. 26.

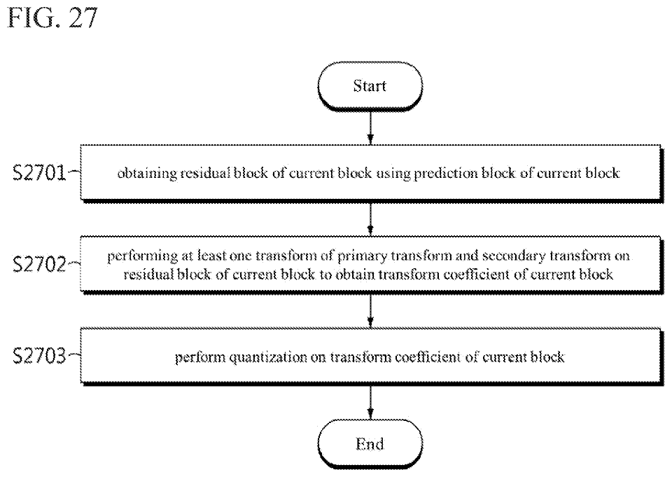

FIG. 27 is a diagram illustrating an image encoding method of the present invention.

Referring to FIG. 27, the image encoding apparatus may obtain a residual block of the current block by using the prediction block erf the current block (S2701).

In addition, the image encoding apparatus may perform at least one transform of the primary transform and the secondary transform on the residual block of the current block to obtain a transform coefficient of the current block (S2702).

Here, the secondary transform may be performed only when the current block is the intra prediction mode. Alternatively, whether to perform the secondary transform may be determined on the basis of the size of the current block.

The secondary transform according to the present invention may be performed between quantization and primary transform.

The secondary transform according to the present invention may be performed using a low frequency transform.

The secondary transform according to the present invention may be performed after rearranging the transform coefficient of the current block from the 2D block format to the 1D list format.

The secondary transform according to the present invention may be performed in an application range determined on the basis of a smaller value of the width or height of the current block.

In addition, the image encoding apparatus may perform quantization on the transform coefficient of the current block (S2703).

In addition, the image encoding apparatus may further perform a step of encoding the transform method selection information indicating the transform method of the secondary transform on the basis of the intra prediction mode of the current block.

The bitstream generated by the image encoding method of the present invention may be temporarily stored in a computer readable non-transitory recording medium, and may be decoded by the above-described image decoding method.

Specifically, in a non-transitory computer readable recording medium including the bitstream decoded by an image decoding apparatus, the bitstream includes transform skip information of the current block and the multiple transform selection information of the current block, the transform skip information indicating whether an inverse transform is performed on the current block, and the multi transform selection information indicating a horizontal transform type and a vertical transform type applied to an inverse transform of the current block, and the multiple transform selection information may be obtained on the basis of the transform skip information in the image decoding apparatus.

The above embodiments may be performed in the same method in an encoder and a decoder.

At least one or a combination of the above embodiments may be used to encode/decode a video.

A sequence of applying to above embodiment may be different between an encoder and a decoder, or the sequence applying to above embodiment may be the same in the encoder and the decoder.

The above embodiment may be performed on each luma signal and chroma signal, or the above embodiment may be identically performed on luma and chroma signals.

A block form to which the above embodiments of the present invention are applied may have a square form or a non-square form.

The above embodiment of the present invention may be applied depending on a size of at least one of a coding block, a prediction block, a transform block, a block, a current block, a coding unit, a prediction unit, a transform unit, a unit, and a current unit. Herein, the size may be defined as a minimum size or maximum size or both so that the above embodiments are applied, or may be defined as a fixed size to which the above embodiment is applied. In addition, in the above embodiments, a first embodiment may be applied to a first size, and a second embodiment may be applied to a second size. In other words, the above embodiments may be applied in combination depending on a size. In addition, the above embodiments may be applied when a size is equal to or greater that a minimum size and equal to or smaller than a maximum size. In other words, the above embodiments may be applied when a block size is included within a certain range.

For example, the above embodiments may be applied when a size of current block is 8×8 or greater. For example, the above embodiments may be applied when a size of current block is 4×4 only. For example, the above embodiments may be applied when a size of current block is 16×16 or smaller. For example, the above embodiments may be applied when a size of current block is equal to or greater than 16×16 and equal to or smaller than 64×64.

The above embodiments of the present invention may be applied depending on a temporal layer. In order to identify a temporal layer to which the above embodiments may be applied, a corresponding identifier may be signaled, and the above embodiments may be applied to a specified temporal layer identified by the corresponding identifier. Herein, the identifier may be defined as the lowest layer or the highest layer or both to which the above embodiment may be applied, or may be defined to indicate a specific layer to which the embodiment is applied. In addition, a fixed temporal layer to which the embodiment is applied may be defined.

For example, the above embodiments may be applied when a temporal layer of a current image is the lowest layer. For example, the above embodiments may be applied when a temporal layer identifier of a current image is 1. For example, the above embodiments may be applied when a temporal layer of a current image is the highest layer.

A slice type or a tile group type to which the above embodiments of the present invention are applied may be defined, and the above embodiments may be applied depending on the corresponding slice type or tile group; type.

At least one of the syntax elements such as the index or the flag, which is entropy encoded by the encoder and entropy decoded by the decoder, may use at least one of the following binarization, debinarization, and entropy encoding/decoding methods. Here, the binarization/inverse binarization and entropy encoding/decoding methods are signed zero-order exponent-golomb (0-th order Exp_Golomb) binarization/debinarization method(se(v)), and signed k-order exponent-golomb (k-th order Exp_Golomb) Binarization/Debinarization Method (sek(v)), 0th-order Exp_Golomb Binarization/Debinarization Method for Unsigned Positive Integers(ue(v)), Signed K-th order Exp_Golomb binarization/debinarization method (uek(v)), fixed-length binarization/debinarization method for positive integers(f(n)), truncated rice binarization/debinarization method or truncated unary binarization/debinarization method (tu(v)), truncated binary binarization/debinarization Method (tb(v)), context-adaptive arithmetic encoding/decoding method (ae(v)), byte unit bit string (b(8)), signed integer binarization/debinarization method (i(n)), and at least one of an unsigned positive integer binarization/debinarization method (u(n)) and an unary binarization/debinarization method.

In the above-described embodiments, the methods are described based on the flowcharts with a series of steps or units, but the present invention is not limited to the order of the steps, and rather, some steps may be performed simultaneously or in different order with other steps. In addition, it should be appreciated by one of ordinary skill in the art that the steps in the flowcharts do not exclude each other and that other steps may be added to the flowcharts or some of the steps may be deleted from the flowcharts without influencing the scope of the present invention.

The embodiments include various aspects of examples. All possible combinations for various aspects may not be described, but those skilled in the art will be able to recognize different combinations. Accordingly, the present invention may include all replacements, modifications, and changes within the scope of the claims.

The embodiments of the present invention may be implemented in a form of program instructions, which are executable by various computer components, and recorded in a computer-readable recording medium. The computer-readable recording medium may include stand-alone or a combination of program instructions, data files, data structures, etc. The program instructions recorded in the computer-readable recording medium may be specially designed and constructed for the present invention, or well-known to a person of ordinary skilled in computer software technology field. Examples of the computer-readable recording medium include magnetic recording media such as hard disks, floppy disks, and magnetic tapes; optical data storage media such as CD-ROMs or DVD-ROMs; magneto-optimum media such as floptical disks; and hardware devices, such as read-only memory (ROM), random-access memory (RAM), flash memory, etc., which are particularly structured to store and implement the program instruction. Examples of the program instructions include not only a mechanical language code formatted by a compiler but also a high level language code that may be implemented by a computer using an interpreter. The hardware devices may be configured to be operated by one or more software modules or vice versa to conduct the processes according to the present invention.

Although the present invention has been described in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

### INDUSTRIAL APPLICABILITY

The present invention may be used to encode or decode an image.

1. A method of decoding an image, the method comprising:
performing dequantization on a current block to obtain a transform coefficient of the current block;
performing at least one inverse transform of primary inverse transform and secondary inverse transform on the transform coefficient of the current block to obtain a residual block of the current block; and
adding the residual block of the current block and a prediction block of the current block to obtain a reconstructed block of the current block,
wherein the secondary inverse transform is performed only when the current block is in an intra prediction mode.

2. The method of claim 1, wherein the secondary inverse transform is performed between the dequantization and the primary inverse transform.

3. The method of claim 1, wherein the secondary inverse transform is performed using a low frequency inverse transform.

4. The method of claim 1, wherein the secondary inverse transform uses a transform method determined according to the intra prediction mode of the current block.

5. The method of claim 1, wherein the secondary inverse transform uses a transform method determined according to transform method selection information obtained from a bit stream.

6. The method of claim 1, wherein whether to perform the secondary inverse transform is determined on the basis of a size of the current block.

7. The method of claim 1, wherein the secondary inverse transform is performed after rearranging the transform coefficient of the current block from a 2D block format to a 1D list format.

8. The method of claim 1, wherein the secondary inverse transform is performed in an application range determined on the basis of a smaller value of a width or a height of the current block.

9. A method of encoding an image, the method comprising:
using a prediction block of a current block to obtain a residual block of the current block;
performing at least one transform of primary transform and secondary transform on the residual block of the current block to obtain a transform coefficient of the current block; and
performing quantization on the transform coefficient of the current block,
wherein the secondary transform is performed only when the current block is in an intra prediction mode.

10. The method of claim 9, wherein the secondary transform is performed between the quantization and the primary transform.

11. The method of claim 9, wherein the secondary transform is performed using a low frequency transform.

12. The method of claim 9, further comprising:
encoding transform method selection information indicating a transform method of the secondary transform on the basis of the intra prediction mode of the current block.

13. The method of claim 9, wherein whether to perform the secondary transform is determined on the basis of a size of the current block.

14. The method of claim 9, wherein the secondary transform is performed after rearranging the transform coefficients of the current block from a 2D block format to a 1D list format.

15. The method of claim 9, wherein the secondary transform is performed in an application range determined on the basis of a smaller value of a width or a height of the current block.

16. A non-transitory computer readable recording medium including a bitstream decoded by an image decoding device,
wherein the bitstream includes transform method selection information;
the transform method selection information indicates a transform method of secondary inverse transform in the image decoding device; and
the secondary inverse transform is performed only when the current block is in the intra prediction mode.
